(19) United States
(12) Patent Application Publication
(10) Pub. No.: US 2026/0088962 A1
(43) Pub. Date: Mar. 26, 2026

(54) CHANNEL STATE INFORMATION TRANSMISSION METHOD AND APPARATUS, TERMINAL, AND NETWORK-SIDE DEVICE

(71) Applicant: VIVO MOBILE COMMUNICATION CO., LTD., Dongguan (CN)

(72) Inventors: Lu JIANG, Dongguan (CN); Xiaohang CHEN, Dongguan (CN); Gen LI, Dongguan (CN)

(73) Assignee: VIVO MOBILE COMMUNICATION CO., LTD., Dongguan (CN)

(21) Appl. No.: 19/409,714

(22) Filed: Dec. 4, 2025

Related U.S. Application Data
(63) Continuation of application No. PCT/CN2024/096204, filed on May 30, 2024.

(30) Foreign Application Priority Data
Jun. 6, 2023 (CN) 202310670914.8

(51) Int. Cl. H04L 5/00; H04W 24/10

(52) U.S. Cl. CPC H04L 5/0057; H04W 24/10

(57) ABSTRACT

A Channel State Information (CSI) transmission method and apparatus, a terminal, and a network-side device, are provided. The method includes sending at least one CSI report. The at least one CSI report includes a first CSI report including at least two pieces of CSI. A mapping order of the at least two pieces of CSI is determined based on first information. The first information includes at least one of the following: second information associated with each of the at least two pieces of CSI, reported content of each of the at least two pieces of CSI, or an order of at least two spatial adaptation patterns or an order of at least two sub-configurations configured or indicated by a network-side device. The at least two spatial adaptation patterns or the at least two sub-configurations are in a one-to-one correspondence with the at least two pieces of CSI.

### CROSS-REFERENCE TO RELATED APPLICATIONS

This application is a continuation of International Application No. PCT/CN2024/096204, filed May 30, 2024, which claims priority to Chinese Patent Application No. 202310670914.8, filed Jun. 6, 2023. The entire contents of each of the above-referenced applications are expressly incorporated herein by reference.

### TECHNICAL FIELD

This application is directed to the field of communication technologies, and specifically, relates to a channel state information transmission method and apparatus, a terminal, and a network-side device.

### BACKGROUND

In a related technology, during reporting of Channel State Information (CSI), one CSI report may include one or more pieces of CSI. However, in a case that one CSI report includes a plurality of pieces of CSI, there is no corresponding solution for a specific order in which the plurality of pieces of CSI in the CSI report are mapped. When a network side activates User Equipment (UE) (which is also referred to as a terminal) to report a plurality of pieces of CSI in the same CSI report, if no unified mapping rule is formulated, the terminal and the network-side device are caused to understand the CSI report inconsistently, thereby affecting CSI reception.

### SUMMARY

Embodiments of this application provide a channel state information transmission method and apparatus, a terminal, and a network-side device.

According to a first aspect, a channel state information transmission method is provided. The method includes:
sending, by a terminal, at least one channel state information CSI report, where
the at least one CSI report includes a first CSI report, the first CSI report includes at least two pieces of CSI, a mapping order of the at least two pieces of CSI is determined based on first information, and the first information includes at least one of the following: second information associated with each of the at least two pieces of CSI, reported content of each of the at least two pieces of CSI, or an order of at least two spatial adaptation patterns or an order of at least two sub-configurations configured or indicated by a network-side device;
the at least two spatial adaptation patterns or the at least two sub-configurations are in a one-to-one correspondence with the at least two pieces of CSI, and the second information includes at least one of the following: a sub-configuration identifier, a spatial adaptation pattern identifier, a resource-related identifier, a codebook configuration identifier, a code division multiplexing group identifier, a code division multiplexing group quantity, a port quantity, a power offset, or a first quantity; and
the first quantity is related to at least one of the following: a quantity of antenna ports in a horizontal direction of one polarization direction on one panel, a quantity of antenna ports in a vertical direction of one polarization direction on one panel, or a quantity of antenna panels.

According to a second aspect, a channel state information transmission apparatus is provided. The apparatus includes:
a sending module, configured to send at least one channel state information CSI report, where
the at least one CSI report includes a first CSI report, the first CSI report includes at least two pieces of CSI, a mapping order of the at least two pieces of CSI is determined based on first information, and the first information includes at least one of the following: second information associated with each of the at least two pieces of CSI, reported content of each of the at least two pieces of CSI, or an order of at least two spatial adaptation patterns or an order of at least two sub-configurations configured or indicated by a network-side device;
the at least two spatial adaptation patterns or the at least two sub-configurations are in a one-to-one correspondence with the at least two pieces of CSI, and the second information includes at least one of the following: a sub-configuration identifier, a spatial adaptation pattern identifier, a resource-related identifier, a codebook configuration identifier, a code division multiplexing group identifier, a code division multiplexing group quantity, a port quantity, a power offset, or a first quantity; and
the first quantity is related to at least one of the following: a quantity of antenna ports in a horizontal direction of one polarization direction on one panel, a quantity of antenna ports in a vertical direction of one polarization direction on one panel, or a quantity of antenna panels.

According to a third aspect, a channel state information transmission method is provided. The method includes:
receiving, by a network-side device, at least one channel state information CSI report, where
the at least one CSI report includes a first CSI report, the first CSI report includes at least two pieces of CSI, a mapping order of the at least two pieces of CSI is determined based on first information, and the first information includes at least one of the following: second information associated with each of the at least two pieces of CSI, reported content of each of the at least two pieces of CSI, or an order of at least two spatial adaptation patterns or an order of at least two sub-configurations configured or indicated by a network-side device;
the at least two spatial adaptation patterns or the at least two sub-configurations are in a one-to-one correspondence with the at least two pieces of CSI, and the second information includes at least one of the following: a sub-configuration identifier, a spatial adaptation pattern identifier, a resource-related identifier, a codebook configuration identifier, a code division multiplexing group identifier, a code division multiplexing group quantity, a port quantity, a power offset, or a first quantity; and
the first quantity is related to at least one of the following: a quantity of antenna ports in a horizontal direction of one polarization direction on one panel, a quantity of antenna ports in a vertical direction of one polarization direction on one panel, or a quantity of antenna panels.

According to a fourth aspect, a channel state information transmission apparatus is provided. The apparatus includes:
a receiving module, configured to receive at least one channel state information CSI report, where
the at least one CSI report includes a first CSI report, the first CSI report includes at least two pieces of CSI, a mapping order of the at least two pieces of CSI is determined based on first information, and the first information includes at least one of the following: second information associated with each of the at least two pieces of CSI, reported content of each of the at least two pieces of CSI, or an order of at least two spatial adaptation patterns or an order of at least two sub-configurations configured or indicated by a network-side device;
the at least two spatial adaptation patterns or the at least two sub-configurations are in a one-to-one correspondence with the at least two pieces of CSI, and the second information includes at least one of the following: a sub-configuration identifier, a spatial adaptation pattern identifier, a resource-related identifier, a codebook configuration identifier, a code division multiplexing group identifier, a code division multiplexing group quantity, a port quantity, a power offset, or a first quantity; and
the first quantity is related to at least one of the following: a quantity of antenna ports in a horizontal direction of one polarization direction on one panel, a quantity of antenna ports in a vertical direction of one polarization direction on one panel, or a quantity of antenna panels.

According to a fifth aspect, a terminal is provided. The terminal includes a processor and a memory. The memory stores a program or instructions capable of running on the processor, and the program or the instructions are executed by the processor to implement the steps of the method according to the first aspect.

According to a sixth aspect, a terminal is provided. The terminal includes a processor and a communication interface, where the communication interface is configured to send at least one channel state information CSI report. The at least one CSI report includes a first CSI report, the first CSI report includes at least two pieces of CSI, a mapping order of the at least two pieces of CSI is determined based on first information, and the first information includes at least one of the following: second information associated with each of the at least two pieces of CSI, reported content of each of the at least two pieces of CSI, or an order of at least two spatial adaptation patterns or an order of at least two sub-configurations configured or indicated by a network-side device. The at least two spatial adaptation patterns or the at least two sub-configurations are in a one-to-one correspondence with the at least two pieces of CSI, and the second information includes at least one of the following: a sub-configuration identifier, a spatial adaptation pattern identifier, a resource-related identifier, a codebook configuration identifier, a code division multiplexing group identifier, a code division multiplexing group quantity, a port quantity, a power offset, or a first quantity. The first quantity is related to at least one of the following: a quantity of antenna ports in a horizontal direction of one polarization direction on one panel, a quantity of antenna ports in a vertical direction of one polarization direction on one panel, or a quantity of antenna panels.

According to a seventh aspect, a network-side device is provided. The network-side device includes a processor and a memory. The memory stores a program or instructions capable of running on the processor, and the program or the instructions are executed by the processor to implement the steps of the method according to the third aspect.

According to an eighth aspect, a network-side device is provided. The network-side device includes a processor and a communication interface, where the communication interface is configured to receive at least one channel state information CSI report. The at least one CSI report includes a first CSI report, the first CSI report includes at least two pieces of CSI, a mapping order of the at least two pieces of CSI is determined based on first information, and the first information includes at least one of the following: second information associated with each of the at least two pieces of CSI, reported content of each of the at least two pieces of CSI, or an order of at least two spatial adaptation patterns or an order of at least two sub-configurations configured or indicated by a network-side device. The at least two spatial adaptation patterns or the at least two sub-configurations are in a one-to-one correspondence with the at least two pieces of CSI, and the second information includes at least one of the following: a sub-configuration identifier, a spatial adaptation pattern identifier, a resource-related identifier, a codebook configuration identifier, a code division multiplexing group identifier, a code division multiplexing group quantity, a port quantity, a power offset, or a first quantity. The first quantity is related to at least one of the following: a quantity of antenna ports in a horizontal direction of one polarization direction on one panel, a quantity of antenna ports in a vertical direction of one polarization direction on one panel, or a quantity of antenna panels.

According to a ninth aspect, a channel state information transmission system is provided. The channel state information transmission system includes a terminal and a network-side device. The terminal may be configured to perform the steps of the channel state information transmission method according to the first aspect, and the network-side device may be configured to perform the steps of the channel state information transmission method according to the third aspect.

According to a tenth aspect, a readable storage medium is provided. The readable storage medium stores a program or instructions, and the program or the instructions are executed by a processor to implement the steps of the method according to the first aspect, or implement the steps of the method according to the third aspect.

According to an eleventh aspect, a chip is provided. The chip includes a processor and a communication interface, and the communication interface is coupled to the processor. The processor is configured to run a program or instructions to implement the steps of the method according to the first aspect or the steps of the method according to the third aspect.

According to a twelfth aspect, a computer program/program product is provided. The computer program/program product is stored in a storage medium. The computer program/program product is executed by at least one processor to implement the steps of the method according to the first aspect or the steps of the method according to the third aspect.

In the embodiments of this application, the terminal sends at least one CSI report. The at least one CSI report includes a first CSI report, the first CSI report includes at least two pieces of CSI, a mapping order of the at least two pieces of CSI is determined based on first information, and the first information includes at least one of the following: second information associated with each of the at least two pieces of CSI, reported content of each of the at least two pieces of CSI, or an order of at least two spatial adaptation patterns or an order of at least two sub-configurations configured or indicated by a network-side device. The at least two spatial adaptation patterns or the at least two sub-configurations are in a one-to-one correspondence with the at least two pieces of CSI, and the second information includes at least one of the following: a sub-configuration identifier, a spatial adaptation pattern identifier, a resource-related identifier, a codebook configuration identifier, a code division multiplexing group identifier, a code division multiplexing group quantity, a port quantity, a power offset, or a first quantity. The first quantity is related to at least one of the following: a quantity of antenna ports in a horizontal direction of one polarization direction on one panel, a quantity of antenna ports in a vertical direction of one polarization direction on one panel, or a quantity of antenna panels. In the embodiments of this application, in a case that the CSI report includes at least two pieces of CSI, the at least two pieces of CSI in the CSI report may be mapped based on the mapping order, determined based on the first information, of the at least two pieces of CSI. To be specific, in the embodiments of this application, in the case that the CSI report includes at least two pieces of CSI, a solution for a mapping order of a plurality of pieces of CSI in the CSI report is provided. According to this solution, it is convenient for the terminal and the network-side device to understand the CSI report consistently.

### BRIEF DESCRIPTION OF DRAWINGS

FIG. 1 is a block diagram of a wireless communication system to which an embodiment of this application is applicable;

FIG. 2 is a schematic diagram of antenna silence for a panel part according to an embodiment of this application;

FIG. 3 is a flowchart of a channel state information transmission method according to an embodiment of this application;

FIG. 4 is a schematic diagram 1 of a mapping order of CSI in a CSI report according to an embodiment of this application;

FIG. 5 is a schematic diagram 2 of a mapping order of CSI in a CSI report according to an embodiment of this application;

FIG. 6a is a schematic diagram 3 of a mapping order of CSI in a CSI report according to an embodiment of this application;

FIG. 6b is a schematic diagram 4 of a mapping order of CSI in a CSI report according to an embodiment of this application;

FIG. 7a is a schematic diagram 1 of omitting some CSI part2 in a CSI report according to an embodiment of this application;

FIG. 7b is a schematic diagram 2 of omitting some CSI part2 in a CSI report according to an embodiment of this application;

FIG. 8 is a flowchart of another channel state information transmission method according to an embodiment of this application;

FIG. 9 is a structural diagram of a channel state information transmission apparatus according to an embodiment of this application;

FIG. 10 is a structural diagram of another channel state information transmission apparatus according to an embodiment of this application;

FIG. 11 is a structural diagram of a communication device according to an embodiment of this application;

FIG. 12 is a structural diagram of a terminal according to an embodiment of this application; and

FIG. 13 is a structural diagram of a network-side device according to an embodiment of this application.

### DETAILED DESCRIPTION

The following describes technical solutions in embodiments of this application with reference to accompanying drawings in the embodiments of this application. The described embodiments are merely some rather than all of the embodiments of this application. All other embodiments obtained by a person of ordinary skill in the art based on embodiments of this application shall fall within the protection scope of this application.

The terms “first,” “second,” and the like in this application are used to distinguish between similar objects instead of describing a specified order or sequence. It should be understood that terms used in this way are interchangeable under appropriate circumstances, so that the embodiments of this application can be implemented in an order other than that illustrated or described herein. Moreover, the terms “first” and “second” typically distinguish between objects of one category rather than limiting a quantity of objects. For example, there may be one or more first objects. In addition, “or” in this application represents at least one of connected objects. For example, “A or B” includes three solutions, that is, a solution 1: including A and not including B; a solution 2: including B and not including A; and a solution 3: including both A and B. The character “/” generally represents an “or” relationship between associated objects.

The term “indication” in this application may be either a direct indication (or an explicit indication) or an indirect indication (or an implicit indication). The direct indication may be understood as follows: A sender explicitly notifies, in a sent indication, a receiver of specific information, an operation that needs to be performed, a requested result, or other content. The indirect indication may be understood as follows: The receiver determines corresponding information based on the indication sent by the sender, or performs determining based on the indication sent by the sender, and determines, based on a determining result, the operation that needs to be performed or the requested result.

It should be noted that the technology described in the embodiments of this application is not limited to a Long Term Evolution (LTE)/LTE-Advanced (LTE-A) system and may also be applied to other wireless communication systems, such as Code Division Multiple Access (CDMA), Time Division Multiple Access (TDMA), Frequency Division Multiple Access (FDMA), Orthogonal Frequency Division Multiple Access (OFDMA), and Single-carrier Frequency-Division Multiple Access (SC-FDMA) systems. The terms “system” and “network” are often used interchangeably in the embodiments of this application. The technology described may be used for the systems and radio technologies described above, as well as other systems and radio technologies. The following describes a New Radio (NR) system for illustrative purposes, and NR terms are used in most of the following descriptions. However, these technologies are also applicable to systems such as a 6th Generation (6G) communication system other than the NR system.

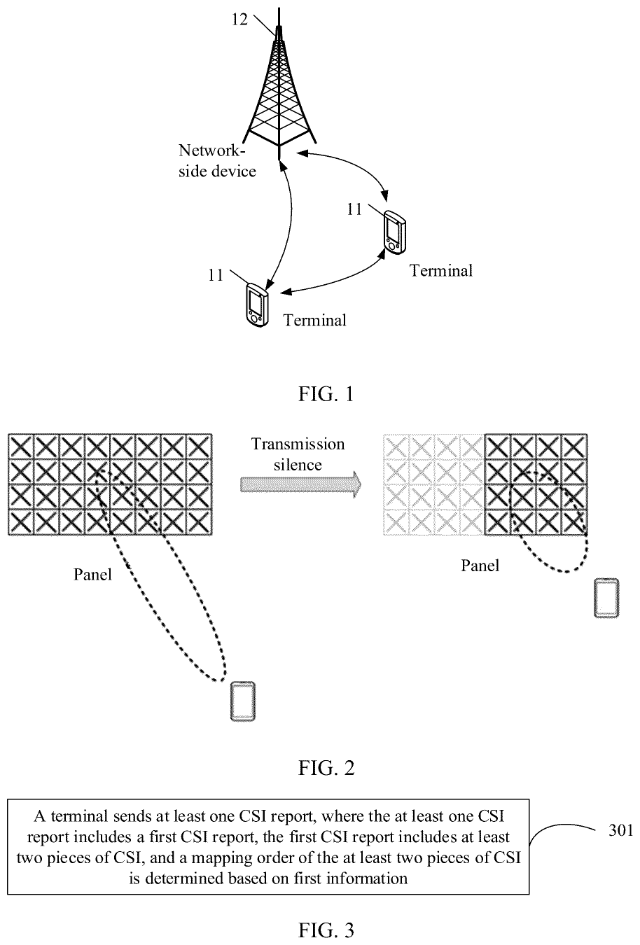

FIG. 1 is a block diagram of a wireless communication system to which an embodiment of this application is applicable. The wireless communication system includes a terminal 11 and a network-side device 12. The terminal 11 may be a mobile phone, a tablet personal computer, a laptop computer, a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, a flight vehicle, Vehicle User Equipment (VUE), ship-mounted equipment, Pedestrian User Equipment (PUE), a smart home (a home device with a wireless communication function, for example, a refrigerator, a television, a laundry machine, or a furniture), a gaming console, a personal computer, a teller machine, a self-service machine, or another terminal-side device. The wearable device includes: a smartwatch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in the embodiments of this application. The network-side device 12 may include an access network device or a core network device. The access network device may also be referred to as a Radio Access Network (RAN) device, a radio access network function, or a radio access network unit. The access network device may include a base station, a Wireless Local Area Network (WLAN) Access Point (AP), a Wireless Fidelity (Wi-Fi) node, and the like. The base station may be referred to as a NodeB (NB), an Evolved NodeB (eNB), a next generation NodeB (gNB), a New Radio NodeB (NR NodeB), an access point, a Relay Base Station (RBS), a Serving Base Station (SBS), a Base Transceiver Station (BTS), a radio base station, a radio transceiver, a Basic Service Set (BSS), an Extended Service Set (ESS), a Home NodeB (HNB), a Home evolved NodeB (HeNB), a Transmission Reception Point (TRP), or another proper term in the art. The base station is not limited to a specific technical term, provided that the same technical effect is achieved. It should be noted that in embodiments of this application, only a base station in an NR system is used as an example for description, and a specific type of the base station is not limited.

The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF) unit, an Edge Application Server Discovery Function (EASDF), Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), an Application Function (AF), or the like. It should be noted that in the embodiments of this application, only a core network device in the NR system is used as an example for description, and a specific type of the core network device is not limited.

For ease of understanding, the following describes some content related to the embodiments of this application.

### I. Network Energy Saving

For a conventional base station, energy saving is mainly achieved by means of on-site power-off, a time-controlled switch, cell blocking, and the like. However, these means cannot take into account user perception. In a 5^{th} Generation (5G) era, because a 5G base station uses a 64-transmit and 64-receive (that is, 64T64R) massive array antenna, supports a higher bandwidth, and so on, energy consumption of the 5G base station is higher than that of a 4^{th} Generation (4G) base station. In addition, a 5G frequency band is high, and a coverage area of a single station is small. To achieve a coverage effect of a 4G network, a deployment scale of the 5G base station is 2 to 3 times that of the 4G base station. Power consumption of the device is higher, a quantity of stations is larger, and electricity consumption is certainly higher. The excessively high power consumption has become a headache in current 5G network operation.

Energy saving of a base station may be divided into symbol shutdown, carrier shutdown, channel shutdown, and deep sleep technology according to an implementation principle. A technical background of energy saving in space domain is as follows: massive Multiple-Input Multiple-Output (mMIMO) consumes much energy because of a large quantity of antennas and a large quantity of corresponding radio frequency components. When a quantity of UEs in a cell is small, a capacity/coverage gain brought by mMIMO is redundant. In this case, the network side may dynamically disable some Transmit Radio frequency Units (that is, TxRUs) to achieve a purpose of network energy saving. As shown in FIG. 2, TxRUs corresponding to some antenna units may be disabled to serve a small quantity of users. After some TxRUs are disabled, a coverage area of a beam decreases, and a beam width increases.

II. Omission of a CSI Part 2 (that is, CSI Part2)

For all CSI reports (that is, CSI reports) on a specific Physical Uplink Shared CHannel (PUSCH), a CSI part 1 (that is, a CSI part1) is first mapped, and then a CSI part2 is mapped. The CSI part2 first ranks WideBand (Wide Band, WB) CSI of all CSI reports ahead based on a priority, and then ranks SubBand (SB) CSI. Subband CSI in each report is arranged by placing an even subband in front of an odd subband. If a resource is insufficient, discarding is performed based on the foregoing arrangement order.

### III. Reported Content of CSI

There are different CSI mapping orders (that is, mapping orders) for reporting of each piece of CSI based on different codebook configurations and different CSI purposes (for example, serving as CSI for beam reporting, serving as CSI for Multi-Transmission and Reception Point (M-TRP) reporting, or serving as CSI for Non-Coherent Joint Transmission (NCJT) reporting. Most of the CSI includes content such as a Channel State Information Reference Signal Resource Indicator (CRI)/Rank Indicator (RI)/Layer Indicator (LI)/wideband Channel Quality Indicator (CQI)/subband differential CQI for a first Transport Block (Subband differential CQI for the first TB)/non-zero wideband amplitude coefficients. For example, one mapping order for reporting wideband CSI may be as follows: A CRI, an RI, and an LI are first reported. Because the LI changes based on a size of the RI, a size of the CSI part1 may be aligned through zero padding. Then, information such as a Precoding Matrix Indicator (PMI) is reported. Table 1 shows a mapping order for reporting wideband CSI. For reporting of the wideband CSI, only a CSI part is included.

TABLE 1

| CSI report | |
|---|---|
| number | CSI field |
| CSI report | CRI, if reported |
| #n | RI, if reported |
| | LI, if reported |
| | Zero padding bit O_{P}, if required |
| | PMI wideband information domain X₁, if reported |
| | PMI wideband information domain X₂, or a codebook |
| | index used for two antenna ports, if reported |
| | Wideband CQI for a first transport block, if reported |
| | Wideband CQI for a second transport block, if reported |

For type I (Type I) and type II (Type II) CSI feedback on the PUSCH (configuration of Type I and Type II is performed by using an information cell “codebook configuration” (CodebookConfig)), CSI reporting includes two parts, where a CSI part 1 has a fixed payload size and is used to identify a quantity of information bits in a CSI part 2. The CSI part1 should be completely transmitted before the CSI part 2.

For the Type I CSI feedback, the CSI part1 includes the following information: an RI (if reported), a CRI (if reported), and a CQI of a first codeword. The CSI part2 includes a PMI (if reported) and includes a CQI of a second codeword when the RI (if reported) is greater than 4.

For the Type II CSI feedback, the CSI part1 includes an RI (if reported), a CQI, and an indicator of a non-zero wideband amplitude coefficient at each layer of Type II CSI, and fields included in the CSI part1 are independently coded. The CSI part2 includes a PMI of Type II CSI. Both the CSI part1 and the CSI part2 are independently coded.

When a higher-layer parameter report quantity (reportQuantity) is configured as one of ‘cri-RSRP’ or ‘ssb-Index-RSRP’, the CSI feedback includes only a single CSI part.

### IV. Reporting Configuration Enhancement

One CSI reporting configuration CSI report #n includes L sub-configurations, and each sub-configuration corresponds to one spatial adaptation pattern. The CSI report #n reports CSI corresponding to N sub-configurations, where both N and L are positive integers, and Nis less than or equal to L.

With reference to the accompanying drawings, the following describes in detail the channel state information transmission method provided in embodiments of this application by using some embodiments and application scenarios thereof.

Referring to FIG. 3, FIG. 3 is a flowchart of a channel state information transmission method according to an embodiment of this application. The method may be performed by a terminal. As shown in FIG. 3, the method includes the following steps.

Step 301: A terminal sends at least one CSI report.

The at least one CSI report includes a first CSI report, the first CSI report includes at least two pieces of CSI, a mapping order of the at least two pieces of CSI is determined based on first information, and the first information includes at least one of the following: second information associated with each of the at least two pieces of CSI, reported content of each of the at least two pieces of CSI, or an order of at least two spatial adaptation patterns or an order of at least two sub-configurations configured or indicated by a network-side device.

The at least two spatial adaptation patterns or the at least two sub-configurations are in a one-to-one correspondence with the at least two pieces of CSI, and the second information includes at least one of the following: a sub-configuration identifier, a spatial adaptation pattern identifier, a resource-related identifier, a codebook configuration identifier, a Code Division Multiplexing Group (CDM Group) identifier, a code division multiplexing group quantity, a port quantity, a power offset, or a first quantity.

The first quantity is related to at least one of the following: a quantity of antenna ports in a horizontal direction of one polarization direction on one panel, a quantity of antenna ports in a vertical direction of one polarization direction on one panel, or a quantity of antenna panels.

In this embodiment, the foregoing first CSI report includes at least two pieces of CSI. For example, the foregoing at least two pieces of CSI may be at least two pieces of CSI that belong to the same CSI report and that are reported at the same time (that is, instance or occasion).

It may be understood that, in a case that a quantity of reported CSI reports is one, the CSI report is the foregoing first CSI report. In a case that the quantity of reported CSI reports is at least two, each of the at least two CSI reports may include at least two pieces of CSI, or some of the at least two CSI reports include one piece of CSI, and the other CSI reports include at least two pieces of CSI. For each CSI report that includes at least two pieces of CSI, a mapping order of the at least two pieces of CSI included in the CSI report may be determined based on the first information.

The reported content of the foregoing CSI may include but is not limited to one or more of a PMI, an RI, a CQI, a CRI, an LI, and the like.

The foregoing spatial adaptation pattern or sub-configuration is a spatial adaptation pattern or sub-configuration associated with or corresponding to the CSI. Each piece of CSI is associated with one spatial adaptation pattern or sub-configuration.

The foregoing resource-related identifier may include an identifier related to a resource. For example, the foregoing resource-related identifier may include but is not limited to at least one of a resource identifier, a resource group identifier, a resource set identifier, or the like. The resource may be a reference signal resource, for example, a Channel State Information Reference Signal (CSI-RS).

The foregoing power offset may be a power offset of a Physical Downlink Shared CHannel (PDSCH) relative to the CSI-RS.

The following describes examples of the embodiments of this application by using different cases.

Case 1: In a case that the first information includes the second information associated with each of the foregoing at least two pieces of CSI, the at least two pieces of CSI may be mapped in decreasing order or increasing order of the associated second information. For example, if the second information includes a sub-configuration identifier (Id), the at least two pieces of CSI may be mapped in decreasing order or increasing order of the associated sub-configuration identifier. If the second information includes the resource-related identifier, the at least two pieces of CSI may be mapped in decreasing order or increasing order of the associated resource-related identifier. If the second information includes the first quantity, the at least two pieces of CSI are mapped in decreasing order or increasing order of the associated first quantity.

Case 2: In a case that the first information includes reported content of each of the foregoing at least two pieces of CSI, a mapping order of the at least two pieces of CSI may be determined based on whether some CSI fields are omitted from the reported content of the at least two pieces of CSI. For example, a mapping order of CSI with some CSI fields being omitted from the reported content precedes a mapping order of CSI with no CSI field being omitted from the reported content, or a mapping order of CSI with CSI field sharing in the reported content precedes a mapping order of CSI without CSI field sharing in the reported content.

Case 3: In a case that the first information includes the order of the at least two spatial adaptation patterns or the order of the at least two sub-configurations configured or indicated by the network-side device, the mapping order of the foregoing at least two pieces of CSI may be determined based on an order of at least two spatial adaptation pattern identifiers or an order of at least two sub-configuration identifiers configured or indicated by the network-side device.

For example, the spatial adaptation pattern is distinguished by different nrofports values. The network-side device configures three types of nrofports for one resource (resource), which are respectively {16, 4, 32}. The terminal performs CSI reporting in an order of the three types of nrofports configured by the network-side device. To be specific, the terminal maps the three pieces of CSI in an order of CSI-1, CSI-2, and CSI-3, where CSI-1 is CSI corresponding to nrofports=16, CSI-2 is CSI corresponding to nrofports-4, and CSI-3 is CSI corresponding to nrofports=32. It should be noted that the foregoing nrofports value is used to configure a quantity of ports (Port) of the CSI-RS resource.

For another example, the spatial adaptation pattern is distinguished by different power control offsets (powerControlOffset), and the network-side device instructs the terminal to report CSI whose three power control offsets are respectively {0, 2, −1} dB. The terminal maps the three pieces of CSI in an order of CSI-1, CSI-2, and CSI-3, where CSI-1 is CSI corresponding to powerControlOffset-OdB, CSI-2 is CSI corresponding to powerControlOffset-2 dB, and CSI-3 is CSI corresponding to powerControlOffset=−1 dB.

According to the channel state information transmission method provided in this embodiment of this application, the terminal sends at least one CSI report. The at least one CSI report includes a first CSI report, the first CSI report includes at least two pieces of CSI, a mapping order of the at least two pieces of CSI is determined based on first information, and the first information includes at least one of the following: second information associated with each of the at least two pieces of CSI, reported content of each of the at least two pieces of CSI, or an order of at least two spatial adaptation patterns or an order of at least two sub-configurations configured or indicated by a network-side device. The at least two spatial adaptation patterns or the at least two sub-configurations are in a one-to-one correspondence with the at least two pieces of CSI, and the second information includes at least one of the following: a sub-configuration identifier, a spatial adaptation pattern identifier, a resource-related identifier, a codebook configuration identifier, a code division multiplexing group identifier, a code division multiplexing group quantity, a port quantity, a power offset, or a first quantity. The first quantity is related to at least one of the following: a quantity of antenna ports in a horizontal direction of one polarization direction on one panel, a quantity of antenna ports in a vertical direction of one polarization direction on one panel, or a quantity of antenna panels. In the embodiments of this application, in a case that the CSI report includes at least two pieces of CSI, the at least two pieces of CSI in the CSI report may be mapped based on the mapping order, determined based on the first information, of the at least two pieces of CSI. To be specific, in the embodiments of this application, in the case that the CSI report includes at least two pieces of CSI, a solution for a mapping order of a plurality of pieces of CSI in the CSI report is provided. According to this solution, it is convenient for the terminal and the network-side device to understand the CSI report consistently.

In some implementations, the resource-related identifier includes at least one of the following:
a CSI-RS resource group identifier (resource group Id), a CSI-RS resource set identifier (resource set Id), or a CSI-RS resource identifier (resource Id).

For example, the CSI-RS resource group identifier may be a non-zero power (Non-zero Power, NZP) CSI-RS resource group identifier, the CSI-RS resource set identifier may be an NZP CSI-RS resource set identifier, and the CSI-RS resource identifier may be an NZP CSI-RS resource identifier.

In some implementations, the first quantity is one of the following:
N1, N2, Ng, N1*N2, N1*N2*Ng, or N1*N2*O1*O2, where
N1 is the quantity of antenna ports in the horizontal direction of one polarization direction on one panel, N2 is the quantity of antenna ports in the vertical direction of one polarization direction on one panel, Ng is the quantity of antenna panels, O1 is an over-sampling multiple in the horizontal direction, and O2 is an over-sampling multiple in the vertical direction.

In some implementations, the at least two pieces of CSI are mapped in decreasing order of the second information, or the at least two pieces of CSI are mapped in increasing order of the second information.

For example, if the second information includes a sub-configuration identifier (that is, an Id), the foregoing at least two pieces of CSI may be mapped in decreasing order or increasing order of the associated sub-configuration identifier. If the second information includes a spatial adaptation pattern identifier, the at least two pieces of CSI may be mapped in decreasing order or increasing order of the associated spatial adaptation pattern identifier. If the second information includes a resource-related identifier, the at least two pieces of CSI may be mapped in decreasing order or increasing order of the associated resource-related identifier. If the second information includes a codebook configuration identifier, the at least two pieces of CSI are mapped in decreasing order or increasing order of the associated codebook configuration identifier. If the second information includes a code division multiplexing group identifier, the at least two pieces of CSI are mapped in decreasing order or increasing order of the associated code division multiplexing group identifier. If the second information includes a code division multiplexing group quantity, the at least two pieces of CSI are mapped in decreasing order or increasing order of the associated code division multiplexing group quantity. If the second information includes a port quantity, the at least two pieces of CSI are mapped in decreasing order or increasing order of the associated port quantity. If the second information includes a power offset, the at least two pieces of CSI are mapped in decreasing order or increasing order of the associated power offset. If the second information includes a first quantity, the at least two pieces of CSI are mapped in decreasing order or increasing order of the associated first quantity.

For example, as shown in Table 2, the network-side device configures six sub-configurations (Sub-configuration) through radio resource control (Radio Resource Control, RRC), and each sub-configuration corresponds to one spatial adaptation pattern (spatial adaptation pattern), which is associated with one NZP-CSI-RS resource group (resource group). Each spatial adaptation pattern may be distinguished by different port subsets (Port Subset)/nrofport port quantity/port index (Port Index), by different CDM groups (CDM Group), by different power offsets (powerControlOffset), or by different NZP CSI-RS resource groups (resource group) or NZP CSI-RS resource sets (resource set).

TABLE 2
Parameter list

| | | | | |
|---|---|---|---|---|
| Sub- | Spatial | NZP-CSI-RS | Port subset 0 | powerControlOffset0 |
| configuration | adaptation | resource group | | |
| Id = 0 | pattern Id = 0 | Id = 0 | | |
| Sub- | Spatial | NZP-CSI-RS | Port subset 1 | powerControlOffset1 |
| configuration | adaptation | resource group | | |
| Id = 1 | pattern Id = 1 | Id = 1 | | |
| Sub- | Spatial | NZP-CSI-RS | Port subset 2 | powerControlOffset2 |
| configuration | adaptation | resource group | | |
| Id = 2 | pattern Id = 2 | Id = 2 | | |
| Sub- | Spatial | NZP-CSI-RS | Port subset 3 | powerControlOffset3 |
| configuration | adaptation | resource group | | |
| Id = 3 | pattern Id = 3 | Id = 3 | | |
| Sub- | Spatial | NZP-CSI-RS | Port subset 4 | powerControlOffset4 |
| configuration | adaptation | resource group | | |
| Id = 4 | pattern Id = 4 | Id = 4 | | |
| Sub- | Spatial | NZP-CSI-RS | Port subset 5 | powerControlOffset5 |
| configuration | adaptation | resource group | | |
| Id = 5 | pattern Id = 5 | Id = 5 | | |

It may be understood that the network-side device needs to configure only one column in the foregoing Table 2 to represent different CSI measurement assumptions. For example, the network-side device configures six NZP-CSI-RS resource groups, which represent six measurement assumptions. Referring to Table 3 to Table 5, the following describes examples of the embodiments by using different cases.

Case 1: The network-side device instructs the UE to report CSI corresponding to {resource group Id=2, 3, and 5}, and then the UE successively maps CSI corresponding to {resource group Id=2, 3, and 5} in CSI report #n (that is, the first CSI report) based on a size of the indicated resource group Id.

A/B/C of the explanation 1 in Table 3 to Table 5 respectively represent 2/3/5. In this case, different resource groups may alternatively be represented by different NZP-CSI-RS resource sets.

Case 2: The network-side device instructs the UE to report CSI corresponding to {spatial adaptation pattern Id=0, 3, and 4}, and then the UE successively maps CSI corresponding to {spatial adaptation pattern Id=0, 3, and 4} in CSI report #n based on a size of the indicated spatial adaptation pattern Id. A/B/C of the explanation 2 in Table 3 to Table 5 respectively represent 0/3/4.

Case 3: The network-side device instructs the UE to report CSI corresponding to {nrofport=4, 8, 32}, and then the UE successively maps CSI corresponding to {nrofport=4, 8, 32} in CSI report #n in increasing order of the port quantity. A/B/C of the explanation 3 in Table 3 to Table 5 respectively represent Apr. 8, 1932.

Case 4: The network-side device instructs the UE to report CSI corresponding to {portsubset Id=0, 1, 2}, and then the UE maps CSI corresponding to {portsubset Id=0, 1, 2} in a target CSI report in increasing order of the port subset Id. A/B/C of the explanation 4 in Table 3 to Table 5 respectively represent 0/1/2.

Case 5: The network-side device distinguishes different spatial adaptation patterns by indicating a CDM group Id, and instructs the UE to report CSI in a disabled state or an enabled state of a port corresponding to {CDM group Id=4, 5, 6, 7}. In this case, the UE successively maps CSI in a disabled state or an enabled state of a port corresponding to {CDM group Id=0, 1} in CSI report #n in increasing order of the CDM group Id. A/B/C of the explanation 2 in Table 3 to Table 5 may be understood as different CDM group disabled/enabled states, where spatial adaptation pattern A represents that a port corresponding to CDM group Id=4 is in a disabled state or an enabled state, spatial adaptation pattern B represents that a port corresponding to CDM group Id=5 is in a disabled state or an enabled state, spatial adaptation pattern C represents that a port corresponding to CDM group Id=6 is in a disabled state or an enabled state, and spatial adaptation pattern D represents that a port corresponding to CDM group Id=7 is in a disabled state or an enabled state.

TABLE 3

| CSI report | | Explanation | Explanation | Explanation | Explanation |
|---|---|---|---|---|---|
| number | CSI field | 1 | 2 | 3 | 4 |
| CSI report | CRI | CSI part1 of | CSI part1 | CSI part1 | CSI part1 |
| #n | RI | CSI whose | of CSI for | of CSI | of CSI |
| CSI part1 | Wideband CQI | resource | the spatial | whose | whose port |
| | for the first | group | adaptation | nroport is A | subset |
| | transport block | identifier is A | pattern A | (CSI part 1 | identifier is |
| | (Wideband CQI | (CSI part 1 of | (CSI part 1 | of the CSI | A |
| | for the first TB) | the CSI for | of the CSI | for nroport = | (CSI part 1 |
| | Subband | resource | for spatial | A) | for the CSI |
| | differential CQI | group Id = A) | adaptation | | for |
| | for the first | | pattern A) | | portsubset |
| | transport block | | | | Id = A) |
| | (Subband | | | | |
| | differential CQI | | | | |
| | for the first TB) | | | | |
| | CRI | CSI part1 of | CSI part1 | CSI part1 | CSI part1 |
| | RI | CSI whose | of CSI for | of CSI | of CSI |
| | Wideband CQI | resource | the spatial | whose | whose port |
| | for the first | group | adaptation | nroport is B | subset |
| | transport block | identifier is B | pattern B | | identifier is |
| | Subband | | | | B |
| | differential CQI | | | | |
| | for the first | | | | |
| | transport block | | | | |
| | CRI | CSI part1 of | CSI part1 | CSI part1 | CSI part1 |
| | RI | CSI whose | of CSI for | of CSI | of CSI |
| | Wideband CQI | resource | the spatial | whose | whose port |
| | for the first | group | adaptation | nroport is C | subset |
| | transport block | identifier is C | pattern C | | identifier is |
| | Subband | | | | C |
| | differential CQI | | | | |
| | for the first | | | | |
| | transport block | | | | |
| | CRI | CSI part1 of | CSI part1 | CSI part1 | CSI part1 |
| | RI | CSI whose | of CSI for | of CSI | of CSI |
| | Wideband CQI | resource | the spatial | whose | whose port |
| | for the first | group | adaptation | nroport is D | subset |
| | transport block | identifier is D | pattern D | | identifier is |
| | Subband | | | | D |
| | differential CQI | | | | |
| | for the first | | | | |
| | transport block | | | | |

TABLE 4

| CSI report | | Explanation | Explanation | Explanation | Explanation |
|---|---|---|---|---|---|
| number | CSI field | 1 | 2 | 3 | 4 |
| CSI part 2 | Wideband CQI | CSI part2 | CSI part2 | CSI part2 | CSI part2 |
| wideband | for the second | wideband of | wideband of | wideband of | wideband of |
| of CSI | transport block | CSI whose | CSI for the | CSI whose | CSI whose |
| report #n | (Wideband CQI | resource | spatial | nroport is A | port subset |
| | for the second | group | adaptation | (CSI part 2 | identifier is |
| | TB) | identifier is A | pattern A | wideband of | A |
| | LI | (CSI part 2 | (CSI part 2 | the CSI for | (CSI part 2 |
| | PMI wideband | wideband of | wideband of | nroport = A) | wideband of |
| | information field | the CSI for | the CSI for | | the CSI for |
| | X1 | resource | spatial | | portsubset |
| | (PMI wideband | group Id = A) | adaptation | | Id = A) |
| | information | | pattern A) | | |
| | fields X1) | | | | |
| | PMI wideband | | | | |
| | information field | | | | |
| | X2 | | | | |
| | (PMI wideband | | | | |
| | information | | | | |
| | fields X2) | | | | |
| | Wideband CQI | CSI part2 | CSI part2 | CSI part2 | CSI part2 |
| | for the second | wideband of | wideband of | wideband of | wideband of |
| | transport block | CSI whose | CSI for the | CSI whose | CSI whose |
| | LI | resource | spatial | nroport is B | port subset |
| | PMI wideband | group | adaptation | | identifier is |
| | information field | identifier is B | pattern B | | B |
| | X1 | | | | |
| | PMI wideband | | | | |
| | information field | | | | |
| | X | | | | |
| | Wideband CQI | CSI part2 | CSI part2 | CSI part2 | CSI part2 |
| | for the second | wideband of | wideband of | wideband of | wideband of |
| | transport block | CSI whose | CSI for the | CSI whose | CSI whose |
| | LI | resource | spatial | nroport is C | port subset |
| | PMI wideband | group | adaptation | | identifier is |
| | information field | identifier is C | pattern C | | C |
| | X1 | | | | |
| | PMI wideband | | | | |
| | information field | | | | |
| | X2 | | | | |
| | Wideband CQI | CSI part2 | CSI part2 | CSI part2 | CSI part2 |
| | for the second | wideband of | wideband of | wideband of | wideband of |
| | transport block | CSI whose | CSI for the | CSI whose | CSI whose |
| | LI | resource | spatial | nroport is D | port subset |
| | PMI wideband | group | adaptation | | identifier is |
| | information field | identifier is D | pattern D | | D |
| | X1 | | | | |
| | PMI wideband | | | | |
| | information field | | | | |
| | X2 | | | | |

TABLE 5

| | | |
|---|---|---|
| CSI part 2 | Subband differential CQIs of second transport | CSI part2 even |
| subband | blocks of all even subbands with an increasing order | subband of CSI whose |
| of CSI | of the subband number | resource group |
| report #n | (Subband differential CQI for the second TB of all | identifier is A (CSI part |
| | even subbands with increasing order of subband | 2 even subband of the |
| | number) | CSI for resource group |
| | PMI subband information fields X2 of all even | Id = A) |
| | subbands with an increasing order of the subband | |
| | number | |
| | (subband information fields X2 of all even subbands | |
| | with increasing order of subband number) | |
| | Subband differential CQIs of second transport | CSI part2 even |
| | blocks of all even subbands with an increasing order | subband of CSI whose |
| | of the subband number | resource group |
| | PMI subband information fields X2 of all even | identifier is B |
| | subbands with an increasing order of the subband | |
| | number | |
| | Subband differential CQIs of second transport | CSI part2 even |
| | blocks of all even subbands with an increasing order | subband of CSI whose |
| | of the subband number | resource group |
| | PMI subband information fields X2 of all even | identifier is C |
| | subbands with an increasing order of the subband | |
| | number | |
| | Subband differential CQIs of second transport | CSI part2 even |
| | blocks of all even subbands with an increasing order | subband of CSI whose |
| | of the subband number | resource group |
| | PMI subband information fields X2 of all even | identifier is D |
| | subbands with an increasing order of the subband | |
| | number | |
| | Subband differential CQIs of second transport | CSI part2 odd subband |
| | blocks of all odd subbands with an increasing order | of CSI whose resource |
| | of the subband number | group identifier is A |
| | (Subband differential CQI for the second TB of all | (CSI part 2 odd |
| | odd subbands with increasing order of subband | subband of the CSI for |
| | number) | resource group Id = A) |
| | PMI subband information fields X2 of all odd | |
| | subbands with an increasing order of the subband | |
| | number | |
| | (PMI subband information fields X2 of all odd | |
| | subbands with increasing order of subband number) | |
| | Subband differential CQIs of second transport | CSI part2 odd subband |
| | blocks of all odd subbands with an increasing order | of CSI whose resource |
| | of the subband number | group identifier is B |
| | PMI subband information fields X2 of all odd | |
| | subbands with an increasing order of the subband | |
| | number | |
| | Subband differential CQIs of second transport | CSI part2 odd subband |
| | blocks of all odd subbands with an increasing order | of CSI whose resource |
| | of the subband number | group identifier is C |
| | PMI subband information fields X2 of all odd | |
| | subbands with an increasing order of the subband | |
| | number | |
| | Subband differential CQIs of second transport | CSI part2 odd subband |
| | blocks of all odd subbands with an increasing order | of CSI whose resource |
| | of the subband number | group identifier is D |
| | PMI subband information fields X2 of all odd | |
| | subbands with an increasing order of the subband | |
| | number | |

It should be noted that explanations in the foregoing tables do not belong to mapping content of CSI, but are merely used to explain the embodiments. To be specific, the foregoing mapping content of CSI includes only a column of the CSI field. In addition, in this example, CSI part1 of all CSI in CSI report #n is first mapped, CSI part2 widebands (wideband) of all CSI in CSI report #n are then mapped, and CSI part2 subbands (subband) of all CSI in CSI report #n are then mapped, where subband-related content is also mapped in an order of placing an even subband in front of an odd subband.

In this embodiment, the foregoing at least two pieces of CSI are mapped in decreasing order of the second information, or the at least two pieces of CSI are mapped in increasing order of the second information, thereby simply ensuring that the terminal and the network-side device understand the foregoing CSI report consistently.

In some implementations, a mapping order of first CSI precedes a mapping order of second CSI; or
a mapping order of first CSI follows a mapping order of second CSI;
the first CSI is CSI with some CSI fields being omitted from reported content in the at least two pieces of CSI; or
the first CSI is CSI with CSI field sharing in reported content in the at least two pieces of CSI; and
the second CSI is CSI except the first CSI in the at least two pieces of CSI.

In this embodiment, CSI fields included in all CSI are the same. For example, CSI fields included in each piece of CSI may be predefined in a protocol. In some implementations, if the reported content of the CSI includes content of each CSI field included in the CSI, the CSI is CSI with no CSI field being omitted from the reported content. If the reported content of the CSI includes only content of some of the CSI fields included in the CSI, the CSI is CSI with some CSI fields being omitted from the reported content. The foregoing omitting some CSI fields may be understood as that corresponding content is not padded or set in some CSI fields (for example, an RI field, a PMI field, or a CQI field).

The foregoing CSI with CSI field sharing may be understood, on a UE side, that some fields such as PMI-related information of the CSI are not reported; and may be understood, on a network side, that the CSI is consistent with at least some CSI fields of other CSI, and in this case, the at least some CSI fields of the CSI may be omitted for reporting.

For example, as shown in Table 6 to Table 8, CSI report #n includes three pieces of CSI, one piece is CSI without CSI field sharing (that is, CSI field sharing), and the other two pieces are CSI with CSI field sharing.

A mapping order of the CSI part1 of CSI report #n is as follows: The CSI part1 of the CSI without CSI field sharing is first mapped, and then the CSI part1 of the CSI with CSI field sharing is mapped. A mapping order of the CSI part2 of CSI report #n is as follows: The CSI part2 of the CSI without CSI field sharing is first mapped, and then the CSI part2 of the CSI with CSI field sharing is mapped. For each piece of CSI, a mapping order of the CSI part2 is as follows: Wideband CSI of the CSI part2 is first mapped, and then subband CSI of the CSI part2 is mapped. A mapping order of the subband CSI of the CSI part2 is as follows: Even subband CSI is first mapped, and then odd subband CSI is mapped.

TABLE 6

| CSI report number | CSI field | Explanation |
|---|---|---|
| CSI report #n | Quantity of pieces of CSI included | Third information |
| CSI part 1 | in CSI report#n = 3 | |
| | CRI = 3 | CSI part 1 of CSI whose |
| | RI | NZP-CIS-RS resource group |
| | Wideband CQI for the first | identifier is 0 |
| | transport block | (Without CSI field sharing) |
| | Subband differential CQI for the | |
| | first transport block | |
| | CRI = 6 | CSI part 1 of CSI whose |
| | RI | NZP-CIS-RS resource group |
| | Wideband CQI for the first | identifier is 1 |
| | transport block | (With CSI field sharing) |
| | Subband differential CQI for the | |
| | first transport block | |
| | CRI = 6 | CSI part 1 of CSI whose |
| | RI | NZP-CIS-RS resource group |
| | Wideband CQI for the first | identifier is 2 |
| | transport block | (With CSI field sharing) |
| | Subband differential CQI for the | |
| | first transport block | |
| | Zero padding (optional) | |

TABLE 7

| CSI report number | CSI field | Explanation |
|---|---|---|
| CSI report #n | Wideband CQI for the second | CSI part 2 wideband of CSI |
| CSI part 2 wideband | transport block | whose NZP-CIS-RS resource |
| | LI | group identifier is 0 |
| | PMI wideband information field | (Without CSI field sharing) |
| | Wideband CQI for the second | CSI part 2 wideband of CSI |
| | transport block | whose NZP-CIS-RS resource |
| | LI | group identifier is 1 |
| | | (With CSI field sharing) |
| | Wideband CQI for the second | CSI part 2 wideband of CSI |
| | transport block | whose NZP-CIS-RS resource |
| | LI | group identifier is 2 |
| | | (With CSI field sharing) |

TABLE 8

| | | |
|---|---|---|
| CSI report #n | Subband differential CQIs of | Even subband of CSI part 2 |
| CSI part 2 subband | second transport blocks of all even | of CSI whose NZP-CIS-RS |
| | subbands with an increasing order | resource group identifier is 0 |
| | of the subband number | (Without CSI field sharing) |
| | PMI subband information fields of | |
| | all even subbands | |
| | Subband differential CQIs of | Even subband of CSI part 2 |
| | second transport blocks of all even | of CSI whose NZP-CIS-RS |
| | subbands with an increasing order | resource group identifier is 1 |
| | of the subband number | (With CSI field sharing) |
| | Subband differential CQIs of | Even subband of CSI part 2 |
| | second transport blocks of all even | of CSI whose NZP-CIS-RS |
| | subbands with an increasing order | resource group identifier is 2 |
| | of the subband number | (With CSI field sharing) |
| | Subband differential CQIs of | Odd subband of CSI part 2 |
| | second transport blocks of all odd | of CSI whose NZP-CIS-RS |
| | subbands with an increasing order | resource group identifier is 0 |
| | of the subband number | (Without CSI field sharing) |
| | PMI subband information fields of | |
| | all odd subbands | |
| | Subband differential CQIs of | Odd subband of CSI part 2 |
| | second transport blocks of all odd | of CSI whose NZP-CIS-RS |
| | subbands with an increasing order | resource group identifier is 1 |
| | of the subband number | (With CSI field sharing) |
| | Subband differential CQIs of | Odd subband of CSI part 2 |
| | second transport blocks of all odd | of CSI whose NZP-CIS-RS |
| | subbands with an increasing order | resource group identifier is 2 |
| | of the subband number | (With CSI field sharing) |

In this embodiment, the mapping order of the CSI is determined based on whether some CSI fields are omitted from or whether CSI field sharing exists in the reported content of the CSI, thereby simply ensuring that the terminal and the network-side device understand the foregoing CSI report consistently in a case of reducing resource overheads.

In some implementations, in a case that there are at least two pieces of first CSI, a mapping order of the at least two pieces of first CSI is determined based on at least one of the following: second information associated with each of the at least two pieces of first CSI, or an order of at least two first spatial adaptation patterns or at least two first sub-configurations configured or indicated by the network-side device, where the at least two first spatial adaptation patterns or the at least two first sub-configurations are in a one-to-one correspondence with the at least two pieces of first CSI;
or
in a case that there are at least two pieces of second CSI, a mapping order of the at least two pieces of second CSI is determined based on at least one of the following: second information associated with each of the at least two pieces of second CSI, or an order of at least two second spatial adaptation patterns or at least two second sub-configurations configured or indicated by the network-side device, where the at least two second spatial adaptation patterns or the at least two second sub-configurations are in a one-to-one correspondence with the at least two pieces of second CSI.

In this embodiment, in a case that the quantity of pieces of the foregoing first CSI (that is, the CSI with some CSI fields being omitted from the reported content) is at least two, a mapping order between the foregoing at least two pieces of first CSI may be determined based on other information in the foregoing first information except the reported content of the CSI, that is, second information associated with each of the at least two pieces of first CSI, and an order of at least two first spatial adaptation patterns or at least two first sub-configurations configured or indicated by the network-side device. It may be understood that the at least two first spatial adaptation patterns are spatial adaptation patterns corresponding to the at least two pieces of first CSI in the at least two spatial adaptation patterns, and the at least two first sub-configurations are sub-configurations corresponding to the at least two pieces of first CSI in the at least two sub-configurations.

Similarly, in a case that the quantity of pieces of the foregoing second CSI (that is, the CSI with no CSI field being omitted from the reported content) is at least two, a mapping order between the foregoing at least two pieces of second CSI may be determined based on other information in the foregoing second information except the reported content of the CSI, that is, second information associated with each of the at least two pieces of second CSI, and an order of at least two second spatial adaptation patterns or at least two second sub-configurations configured or indicated by the network-side device. It may be understood that the at least two second spatial adaptation patterns are spatial adaptation patterns corresponding to the at least two pieces of second CSI in the at least two spatial adaptation patterns, and the at least two second sub-configurations are sub-configurations corresponding to the at least two pieces of second CSI in the at least two sub-configurations.

In some implementations, the spatial adaptation pattern or the sub-configuration includes at least one of the following:
a spatial adaptation pattern identifier;
a sub-configuration identifier;
a CSI-RS resource group identifier;
a CSI-RS resource identifier;
a port quantity;
a port subset;
a power offset;
a quantity of antenna ports in a horizontal direction of a single polarization direction on each panel;
a quantity of antenna ports in a vertical direction of a single polarization direction on each panel;
a quantity of antenna ports;
reported content of CSI; or
a codebook configuration.

For example, the foregoing power offset may be a power offset of a PDSCH relative to the CSI-RS. The foregoing CSI-RS resource group identifier may be a Non-Zero Power (NZP) CSI-RS resource group identifier. The foregoing CSI-RS resource identifier may be an NZP CSI-RS resource identifier. The foregoing reported content of the CSI is referred to as reporting quality (ReportQuality) in a standard protocol.

In some implementations, the port subset includes at least one of the following: a port subset identifier or a CDM group identifier.

In some implementations, the codebook configuration includes at least one of the following: a codebook configuration identifier, a CodeBook Subset Restriction (CBSR) parameter, an RI Restriction parameter, or a Codebook Type.

It should be noted that the identifiers used in the foregoing implementations may also be referred to as Id. For example, the codebook configuration identifier may be referred to as a codebook configuration Id.

In some implementations, the first CSI report further includes third information, and the third information is used to assist the network-side device in confirming content of the first CSI report.

In this embodiment, the foregoing third information is used to assist the network-side device in confirming, understanding, or parsing content of the first CSI report. For example, the third information may include at least one of a quantity of pieces of CSI included in the first CSI report, a quantity of sub-configurations associated with the CSI included in the first CSI report, or the like. This helps the network-side device correctly parse the foregoing CSI report, thereby alleviating a problem of inconsistent understanding of the network-side device and the terminal caused by activating reporting of a plurality of pieces of CSI by using group common Downlink Control Information (DCI).

In some implementations, the third information includes at least one of the following:
a quantity of pieces of CSI included in the first CSI report;
a quantity of sub-configurations associated with the CSI included in the first CSI report;
a quantity of spatial adaptation patterns associated with the CSI included in the first CSI report;
a CRI associated with the CSI included in the first CSI report;
a CSI-RS resource group identifier associated with the CSI included in the first CSI report;
a CSI-RS resource identifier associated with the CSI included in the first CSI report;
a spatial adaptation pattern identifier associated with the CSI included in the first CSI report; or
a sub-configuration identifier associated with the CSI included in the first CSI report.

For example, the CSI-RS resource group identifier may be an NZP CSI-RS resource group identifier. The CSI-RS resource identifier may be an NZP CSI-RS resource identifier.

In some implementations, a mapping order of the third information precedes the mapping order of the at least two pieces of CSI.

In this embodiment, the mapping order of the foregoing third information precedes the mapping order of the foregoing at least two pieces of CSI, so that the network-side device can preferentially obtain the third information through parsing, and then can parse all CSI included in the entire CSI report based on the third information.

In some implementations, the third information is located in a CSI part 1 of the first CSI report.

In actual application, for each CSI report, a CSI part 1 (that is, CSI part1) is usually decoded first, and then a CSI part 2 (that is, CSI part2) is decoded. In this embodiment, the third information is included in the CSI part1 of the first CSI report, thereby helping preferentially obtain the foregoing third information through parsing.

In some implementations, the third information may be located in the CSI part1 of the foregoing first CSI report, and be arranged in front of the CSI part1 of the foregoing at least two pieces of CSI. For example, as shown in Table 9, a quantity of loads of the CSI part1 of the CSI report #n (that is, the foregoing first CSI report) is fixed. The CSI report #n includes two pieces of CSI, that is, CSI corresponding to a non-zero power CSI-RS resource group identifier 1 (that is, CSI for NZP-CIS-RS resource group Id=1) and CSI corresponding to a non-zero power CSI-RS resource group identifier 2 (that is, CSI for NZP-CIS-RS resource group Id=2). Third information of the CSI report #n is mapped to a first location of a CSI field in the CSI report. When the network-side device decodes the CSI part1 of the CSI report #n based on a fixed bit quantity, a quantity of pieces of CSI included in the CSI report #n may be first obtained through parsing, and then CSI of a specific resource group corresponding to each piece of CSI may be identified based on the CRI.

TABLE 9

| CSI report number | CSI field | Explanation |
|---|---|---|
| CSI report #n | Quantity of pieces of CSI included in CSI | Third information |
| CSI part 1 | report#n = 2 | |
| | CRI = 3 | CSI part 1 of the CSI for |
| | RI | NZP-CIS-RS resource |
| | Wideband CQI for the first transport | group Id = 0 |
| | block | |
| | (Wideband CQI for the first TB) | |
| | Subband differential CQI for the first | |
| | transport block | |
| | (Subband differential CQI for the first | |
| | TB) | |
| | CRI = 6 | CSI part 1 of the CSI for |
| | RI | NZP-CIS-RS resource |
| | Wideband CQI for the first transport | group Id = 1 |
| | block | |
| | Subband differential CQI for the first | |
| | transport block | |
| | Zero padding | |

It should be noted that subbands of a given CSI report n indicated by a higher-level parameter CSI report bandwidth (csi-ReportingBand) are consecutively numbered in increasing order, and a lowest subband of csi-ReportingBand is subband 0.

In some implementations, a quantity of loads of the CSI part 1 is a fixed value.

In this embodiment, a quantity of loads of the CSI part 1 of the first CSI report is a fixed value. This helps accurately obtain content of the CSI part 1 of the first CSI report through parsing.

In some implementations, the quantity of loads of the CSI part 1 is related to at least one of the following: the quantity of pieces of CSI included in the first CSI report, or CSI reporting capability information of the terminal; and
the CSI reporting capability information is used to indicate a maximum quantity of pieces of CSI that the terminal supports reporting in the same CSI report.

In some implementations, the foregoing quantity of pieces of CSI included in the first CSI report may be equal to the foregoing quantity of pieces of CSI indicated by the third information.

The foregoing CSI reporting capability information is used to indicate a capability of the terminal for reporting CSI, that is, a maximum quantity of pieces of CSI that the terminal supports reporting in the same CSI report, or a maximum quantity of pieces of CSI that the terminal allows the same CSI report to include. For example, if the maximum quantity of pieces of CSI that the terminal supports reporting in the same CSI report is 3, the foregoing quantity of loads of the CSI part 1 may be a size of CSI part1 of three pieces of CSI.

The following describes this embodiment by way of example with reference to Table 10.

As shown in Table 10, a configuration of the CSI report #n includes L sub-configurations, and each sub-configuration corresponds to one spatial adaptation pattern (spatial adaptation pattern). Different NZP CSI-RS resource groups (resource group) distinguish different spatial adaptation patterns. The CSI report #n reports CSI corresponding to N sub-configurations, where N is an integer less than or equal to L, and Lis a CSI reporting capability reported by the UE, which represents a maximum quantity of pieces of CSI that can be configured by the network-side device on the same reporting occasion (report instance) in the CSI report #n.

In this example, the CSI reporting capability reported by the UE is 3, that is, the UE allows the CSI report #n to include a maximum of three pieces of CSI. In this case, a quantity of bits of the CSI part of the CSI report #n is fixed to a size of the CSI part1 of the three pieces of CSI. If the network-side device configures the UE to report two pieces of CSI for two NZP CSI-RS resource groups (respectively NZP CSI-RS resource group0 and NZP CSI-RS resource group1, where NZP CSI-RS resource group0 includes resource0, 1, 2, and 3, and NZP CSI-RS resource group 1 includes resource4, 5, 6, and 7), that is, the CSI report #n includes two pieces of CSI, and each CSI part1 includes a CRI, an RI, a wideband CQI for the first transport block (Wideband CQI for the first TB), and a subband differential CQI for the first transport block (Subband differential CQI for the first TB), a mapping order of the CSI part1 of the CSI report #n is as follows: A CSI part1 of CSI with a smaller resource group Id is first mapped, and mapping is performed in increasing order of the resource group Id. Because a quantity of bits of the CSI part1 is insufficient, and the CSI reporting capability reported by the UE is 3, the bits of the CSI part1 are fixed to the CSI part1 of the three pieces of CSI. In this embodiment, the UE is configured to report only two pieces of CSI, and in this case, a remaining bit is padded with zero. The network-side device learns, based on the CSI reporting capability L=3 reported by the UE, that the quantity of bits of the CSI part1 of the CSI report #n should be a quantity of bits of three CSI part1, and performs decoding in order to learn a CRI of the first piece of CSI. Because CRI=2 and resource Id being equal to 2 belong to NZP CSI-RS group 0, the network-side device may understand that the first CSI is corresponding CSI based on NZP CSI-RS resource group0. A second resource with CRI=7 and resource Id=7 belongs to NZP CSI-RS resource group1, and in this case, the network-side device may understand that the second CSI is corresponding CSI based on NZP CSI-RS resource group1.

In this example, because the network-side device configures a plurality of resource groups in advance, a plurality of resource Ids are configured for each resource group, and no duplicate resource Id is configured between the resource groups, the network-side device may identify, by using the CRI, CSI corresponding to a specific resource group to which the CSI belongs.

TABLE 10

| CSI report number | CSI field | Explanation |
|---|---|---|
| CSI report #n | CRI = 2 | CSI part1 of CSI whose NZP-CIS-RS |
| CSI part 1 | RI | resource group identifier is 0 |
| | Wideband CQI for the first | (CSI part 1 of the CSI for NZP-CIS- |
| | transport block | RS resource group Id = 0) |
| | Subband differential CQI for | |
| | the first transport block | |
| | CRI = 7 | CSI part1 of CSI whose NZP-CIS-RS |
| | RI | resource group identifier is 1 |
| | Wideband CQI for the first | |
| | transport block | |
| | Subband differential CQI for | |
| | the first transport block | |
| | Zero padding | |

In some implementations, a CSI part 1 of each piece of CSI included in the first CSI report includes the third information.

In this embodiment, the CSI part 1 of the first CSI report includes a CSI part 1 of each piece of CSI included in the first CSI report, and the CSI part 1 of each piece of CSI includes third information.

In some implementations, for the CSI part 1 of each piece of CSI, the third information may be preferentially mapped. In other words, in the CSI part 1 of each piece of CSI, the third information is arranged in front of other reported content (for example, a CRI, an RI, and a CQI) of the CSI. For example, as shown in Table 11, a quantity of loads of the CSI part1 of the CSI report #n is fixed, the CSI report #n includes two pieces of CSI, and a first location of the CSI part of each piece of CSI is mapped to the foregoing third information, where the third information may be a Non-Zero Power (NZP) CSI-RS resource group identifier (resource group Id), a spatial adaptation pattern identifier (spatial adaptation pattern Id), and the like.

TABLE 11

| CSI report | |
|---|---|
| number | CSI field |
| CSI report #n | Third information |
| CSI part1 | CRI = 2 |
| | RI |
| | Wideband CQI for the first transport block |
| | (Wideband CQI for the first TB) |
| | Subband differential CQI for the first transport block |
| | (Subband differential CQI for the first TB) |
| | Third information |
| | CRI = 7 |
| | RI |
| | Wideband CQI for the first transport block |
| | Subband differential CQI for the first transport block |
| | Zero padding |

It should be noted that subbands of a given CSI report n indicated by a higher-level parameter CSI report bandwidth (csi-ReportingBand) are consecutively numbered in increasing order, and a lowest subband of csi-ReportingBand is subband 0.

In some implementations, a subband differential channel quality indicator CQI of a first transport block of each of the at least two pieces of CSI is separately located in a CSI part 2 of the piece of CSI.

In this embodiment, a subband differential channel quality indicator for the first transport block of the CSI part1 of each piece of CSI is placed in the CSI part2 of the CSI. Because the subband information is less important than the wideband information, the quantity of bits of the CSI part1 can be reduced, and it is preferentially ensured that the CSI part1 can be correctly parsed. The following describes this embodiment by way of example with reference to Table 12 and Table 13.

TABLE 12

| CSI report | | | | | |
|---|---|---|---|---|---|
| number | CSI field | Explanation 1 | Explanation 2 | Explanation 3 | Explanation 4 |
| CSI report | CRI | CSI part1 of | CSI part1 of | CSI part1 of | CSI part1 of |
| #n | RI | CSI whose | CSI for the | CSI whose | CSI whose |
| CSI part 1 | Wideband CQI for | resource | spatial | nroport is A | port subset |
| | the first transport | group | adaptation | | identifier is |
| | block | identifier is A | pattern A | | A |
| | CRI | CSI part1 of | CSI part1 of | CSI part1 of | CSI part1 of |
| | RI | CSI whose | CSI for the | CSI whose | CSI whose |
| | Wideband CQI for | resource | spatial | nroport is B | port subset |
| | the first transport | group | adaptation | | identifier is |
| | block | identifier is B | pattern B | | B |
| | CRI | CSI part1 of | CSI part1 of | CSI part1 of | CSI part1 of |
| | RI | CSI whose | CSI for the | CSI whose | CSI whose |
| | Wideband CQI for | resource | spatial | nroport is C | port subset |
| | the first transport | group | adaptation | | identifier is |
| | block | identifier is C | pattern C | | C |
| | CRI | CSI part1 of | CSI part1 of | CSI part1 of | CSI part1 of |
| | RI | CSI whose | CSI for the | CSI whose | CSI whose |
| | Wideband CQI for | resource | spatial | nroport is D | port subset |
| | the first transport | group | adaptation | | identifier is |
| | block | identifier is D | pattern D | | D |
| | Zero padding | | | | |

TABLE 13

| CSI | | | | | |
|---|---|---|---|---|---|
| report | | Explanation | Explanation | Explanation | Explanation |
| number | CSI field | 1 | 2 | 3 | 4 |
| CSI part | Wideband CQI for | CSI part2 | CSI part2 | CSI part2 | CSI part2 |
| 2 | the second | wideband of | wideband of | wideband | wideband |
| wideband | transport block | CSI whose | CSI for the | of CSI | of CSI |
| of CSI | Subband | resource | spatial | whose | whose port |
| report #n | differential CQI for | group | adaptation | nroport is A | subset |
| | the first transport | identifier is | pattern A | | identifier is |
| | block | A | | | A |
| | LI | | | | |
| | PMI wideband | | | | |
| | information field | | | | |
| | X1 | | | | |
| | PMI wideband | | | | |
| | information field | | | | |
| | X2 | | | | |
| | Wideband CQI for | CSI part2 | CSI part2 | CSI part2 | CSI part2 |
| | the second | wideband of | wideband of | wideband | wideband |
| | transport block | CSI whose | CSI for the | of CSI | of CSI |
| | Subband | resource | spatial | whose | whose port |
| | differential CQI for | group | adaptation | nroport is B | subset |
| | the first transport | identifier is | pattern B | | identifier is |
| | block | B | | | B |
| | RI | | | | |
| | PMI wideband | | | | |
| | information field | | | | |
| | X1 | | | | |
| | PMI wideband | | | | |
| | information field | | | | |
| | X2 | | | | |
| | Wideband CQI for | CSI part2 | CSI part2 | CSI part2 | CSI part2 |
| | the second | wideband of | wideband of | wideband | wideband |
| | transport block | CSI whose | CSI for the | of CSI | of CSI |
| | Subband | resource | spatial | whose | whose port |
| | differential CQI for | group | adaptation | nroport is C | subset |
| | the first transport | identifier is | pattern C | | identifier is |
| | block | C | | | C |
| | RI | | | | |
| | PMI wideband | | | | |
| | information field | | | | |
| | X1 | | | | |
| | PMI wideband | | | | |
| | information field | | | | |
| | X2 | | | | |
| | Wideband CQI for | CSI part2 | CSI part2 | CSI part2 | CSI part2 |
| | the second | wideband of | wideband of | wideband | wideband |
| | transport block | CSI whose | CSI for the | of CSI | of CSI |
| | Subband | resource | spatial | whose | whose port |
| | differential CQI for | group | adaptation | nroport is C | subset |
| | the first transport | identifier is | pattern C | | identifier is |
| | block | C | | | C |
| | RI | | | | |
| | PMI wideband | | | | |
| | information field | | | | |
| | X1 | | | | |
| | PMI wideband | | | | |
| | information field | | | | |
| | X2 | | | | |

In this example, a subband differential CQI of one transport block in the CSI part 1 of each piece of CSI is mapped to the CSI part2 of the CSI. In this way, the CSI part1 of each piece of CSI includes only a CRI, an RI, and a wideband CQI for the first transport block, thereby reducing the quantity of bits of the CSI part1 of the CSI report #n. When a resource is insufficient, the CSI part2 of the CSI report #n may be omitted or discarded according to an existing mechanism. An overall mapping order of the CSI report #n is still as follows: part1 of all CSI in the CSI report #n is first mapped, and then part2 of all CSI in the CSI report #n is mapped.

In some implementations, in a case that the at least two pieces of CSI include third CSI, a CSI part 2 of the third CSI includes only wideband CSI; and
the third CSI is CSI with CSI field sharing in reported content in the at least two pieces of CSI.

In this embodiment, for CSI with CSI field sharing (that is, with CSI field sharing), subband CSI of the CSI may not be mapped, and only wideband CSI of the CSI is mapped. In this way, resource overheads can be reduced.

For example, as shown in Table 14, the CSI report #n includes three pieces of CSI, that is, CSI whose NZP-CIS-RS resource group identifier is 0 (that is, CSI for NZP-CIS-RS resource group Id=0), CSI whose NZP-CIS-RS resource group identifier is 1 (that is, CSI for NZP-CIS-RS resource group Id=1), and CSI whose NZP-CIS-RS resource group identifier is 2 (that is, CSI for NZP-CIS-RS resource group Id=2), where the CSI whose NZP-CIS-RS resource group identifier is 0 does not involve CSI field sharing, and both the CSI whose NZP-CIS-RS resource group identifier is 1 and the CSI whose NZP-CIS-RS resource group identifier is 2 involve CSI field sharing. To be specific, both the CSI whose NZP-CIS-RS resource group identifier is 1 and the CSI whose NZP-CIS-RS resource group identifier is 2 share subband CSI of a CSI part2 of the CSI whose NZP-CIS-RS resource group identifier is 0.

TABLE 14

| CSI report number | CSI field | Explanation |
|---|---|---|
| CSI report #n | CSI part1 | CSI whose NZP-CIS-RS resource group |
| | CSI part2 wideband | identifier is 0 (CSI for NZP-CIS-RS |
| | CSI part2 subband | resource group Id = 0) (without CSI field |
| | | sharing) |
| | CSI part1 | CSI whose NZP-CIS-RS resource group |
| | CSI part2 wideband | identifier is 1 (with CSI field sharing) |
| | CSI part1 | CSI whose NZP-CIS-RS resource group |
| | CSI part2 subband | identifier is 2 (with CSI field sharing |
| | Zero padding | |
| | (optional) | |

In some implementations, each piece of CSI of the first CSI report may be mapped as a whole, that is, a CSI part1 and a CSI part2 of each piece of CSI are not split.

For example, as shown in Table 15, the CSI report #n includes two pieces of CSI, that is, CSI whose NZP-CIS-RS resource group identifier is 0 (that is, CSI for NZP-CIS-RS resource group Id=0) and CSI whose NZP-CIS-RS resource group identifier is 1 (that is, CSI for NZP-CIS-RS resource group Id=1). Each piece of CSI is mapped to the CSI report #n as a whole (including a CSI part1 and a CSI part2), and a whole of the CSI report #n is also a fixed quantity of bits. For example, the quantity of bits is a size of three pieces of CSI.

TABLE 15

| CSI report | | |
|---|---|---|
| number | CSI field | Explanation |
| CSI report | CSI part1 | CSI whose NZP-CIS-RS resource group |
| #n | CSI part2 | identifier is 0 |
| | CSI part1 | CSI whose NZP-CIS-RS resource group |
| | CSI part2 | identifier is 1 |
| | Zero padding | |

In some implementations, the CSI part 1 of the first CSI report includes CSI parts 1 of the at least two pieces of CSI, and the CSI parts 1 of the at least two pieces of CSI are arranged in a first mapping order;
or
a CSI part 2 of the first CSI report includes CSI parts 2 of the at least two pieces of CSI, and the CSI parts 2 of the at least two pieces of CSI are arranged in the first mapping order, where
the first mapping order is the mapping order, determined based on the first information, of the at least two pieces of CSI.

In this embodiment, the CSI parts 1 of the foregoing at least two pieces of CSI are both located in the CSI part 1 of the first CSI report, and the CSI parts 1 of the at least two pieces of CSI are arranged in the first mapping order. The CSI parts 2 of the at least two pieces of CSI are both located in the CSI part 2 of the first CSI report, and the CSI parts 2 of the at least two pieces of CSI are arranged in the first mapping order. For example, as shown in Table 3 to Table 5, this arrangement not only provides better compatibility for a structure of a CSI report in a related technology, but also helps ensure that the network-side device can accurately obtain a CSI part 1 of each piece of CSI through parsing.

In some implementations, wideband CSI of each of the CSI parts 2 of the at least two pieces of CSI is arranged in front of subband CSI of each of the CSI parts 2 of the at least two pieces of CSI, and the wideband CSI of the CSI parts 2 of the at least two pieces of CSI is arranged in the first mapping order.

In this embodiment, wideband CSI of each of the CSI parts 2 of the at least two pieces of CSI is arranged in front of subband CSI of each of the CSI parts 2 of the at least two pieces of CSI. In other words, the wideband CSI of the CSI parts 2 of the at least two pieces of CSI is preferentially mapped. This can preferentially ensure transmission of the wideband CSI of the CSI parts 2 of the at least two pieces of CSI. In addition, the wideband CSI of the CSI parts 2 of the at least two pieces of CSI is arranged in the first mapping order. This can help the network-side device accurately obtain the wideband CSI of the CSI part 2 of each piece of CSI through parsing.

In some implementations, even subband CSI of each of the CSI parts 2 of the at least two pieces of CSI is arranged in front of odd subband CSI of each of the CSI parts 2 of the at least two pieces of CSI, the even subband CSI of the CSI parts 2 of the at least two pieces of CSI is arranged in the first mapping order, and the odd subband CSI of the CSI parts 2 of the at least two pieces of CSI is arranged in the first mapping order;
or
the subband CSI of the CSI parts 2 of the at least two pieces of CSI is arranged in the first mapping order, and even subband CSI of a CSI part 2 of each of the at least two pieces of CSI is separately arranged in front of odd subband CSI of the CSI part 2 of the piece of CSI.

In an implementation, even subband CSI of each of the CSI parts 2 of the at least two pieces of CSI is arranged in front of odd subband CSI of each of the CSI parts 2 of the at least two pieces of CSI. In other words, the even subband CSI of the CSI parts 2 of the at least two pieces of CSI is preferentially mapped. This can preferentially ensure transmission of the even subband CSI of the CSI parts 2 of the at least two pieces of CSI. In addition, the even subband CSI of the CSI parts 2 of the at least two pieces of CSI is arranged in the first mapping order, and the odd subband CSI of the CSI parts 2 of the at least two pieces of CSI is arranged in the first mapping order. This can help the network-side device accurately obtain the even subband CSI and the odd subband CSI of the CSI part 2 of each piece of CSI through parsing.

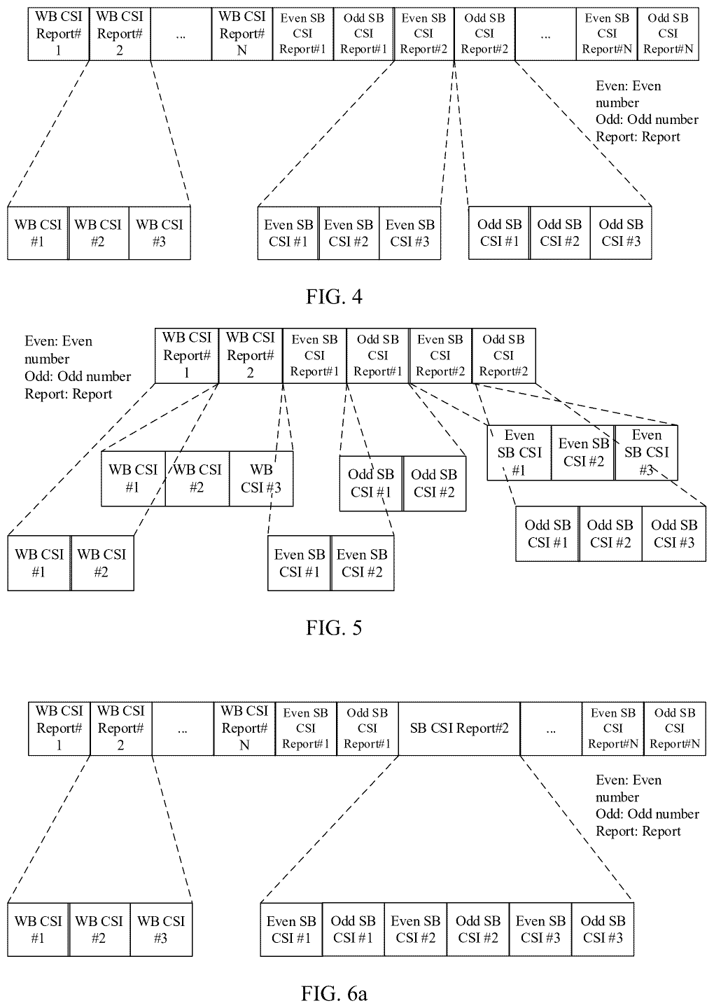

For example, if there are N CSI reports on the PUSCH or the PUCCH, where N is an integer greater than 1, a mapping order or a priority order between the N CSI reports may be determined in a manner in a related technology. It is assumed that the mapping order or the priority order between the N CSI reports determined in the manner in the related technology is as follows: CSI Report #1 is higher than CSI Report #2, CSI Report #2 is higher than CSI Report #3, and by analogy, . . . . CSI Report #N-1 is higher than CSI Report #N. For the CSI report #2, the network-side device activates three sub-configurations, that is, the CSI report #2 includes three pieces of CSI for different sub-configurations. CSI #1, CSI #2, and CSI #3 are respectively CSI corresponding to the activated sub-configuration Ids in increasing order. In this case, a priority order of a CSI part2 of the N CSI reports may be shown in FIG. 4. To be specific, WBs of various CSI reports are arranged in the priority order, and then SBs of the various CSI reports continue to be arranged in the priority order, where the SBs are arranged in an order of placing even subbands (that is, Even SB) in front of odd subbands (Odd SB). In a case that one CSI report includes a plurality of pieces of CSI, the plurality of pieces of CSI may be mapped based on a first mapping order. Similarly, if a plurality of CSI reports include CSI corresponding to a plurality of sub-configurations, a plurality of pieces of CSI in each CSI report are all mapped based on the first mapping order. For example, as shown in FIG. 5, CSI report #1 includes CSI corresponding to two sub-configurations, and CSI report #2 includes CSI corresponding to three sub-configurations.

In another implementation, the subband CSI of the CSI part 2 of each of the at least two pieces of CSI is mapped as a whole. This helps the network-side device completely obtain the subband CSI of the CSI part 2 of each piece of CSI through parsing.

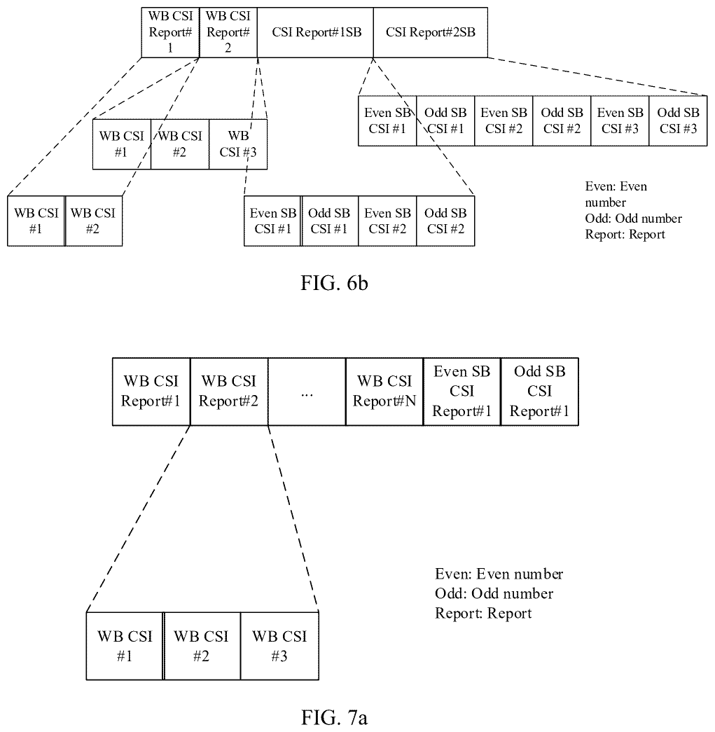

For example, if there are N CSI reports on the PUSCH or the PUCCH, where Nis an integer greater than 1, a mapping order or a priority order between the N CSI reports may be determined in a manner in a related technology. It is assumed that the mapping order or the priority order between the N CSI reports determined based on the related technology is as follows: CSI Report #1 is higher than CSI Report #2, CSI Report #2 is higher than CSI Report #3, and by analogy, . . . . CSI Report #N-1 is higher than CSI Report #N. For the CSI report #2, the network-side device activates three sub-configurations, that is, the CSI report #2 includes three pieces of CSI for different sub-configurations. CSI #1, CSI #2, and CSI #3 are respectively CSI corresponding to the activated sub-configuration Ids in increasing order. In this case, a priority order of a CSI part2 of the N CSI reports may be shown in FIG. 6a. Similarly, if a plurality of CSI reports include CSI corresponding to a plurality of sub-configurations, a plurality of pieces of CSI in each CSI report are all mapped based on the first mapping order. For example, as shown in FIG. 6b, CSI report #1 includes CSI corresponding to two sub-configurations, and CSI report #2 includes CSI corresponding to three sub-configurations.

In some implementations, the method further includes:
in a case that each of the at least one CSI report includes a CSI part 1 and a CSI part 2, omitting or discarding, by the terminal, at least some of the CSI parts 2 of the at least one CSI report based on a target priority order, where
the target priority order includes at least one of a first priority order, a second priority order, or a third priority order;
the first priority order includes a priority order between the CSI parts 2 of the at least one CSI report;
the second priority order includes: a priority of wideband CSI of each of CSI parts 2 of all CSI included in each of the at least one CSI report is separately higher than a priority of subband CSI of each of the CSI parts 2 of all the CSI included in the CSI report; and
the third priority order includes: a priority of even subband CSI of a CSI part 2 of each piece of CSI included in each CSI report is separately higher than a priority of odd subband CSI of the CSI part 2 of the piece of CSI included in the CSI report, or a priority of even subband CSI of each of CSI parts 2 of all CSI included in each CSI report is separately higher than a priority of odd subband CSI of each of the CSI parts 2 of all the CSI included in the CSI report.

In this embodiment, the priority order between the CSI parts 2 of the at least one CSI report may be determined based on the related technology. For example, the priority order between the foregoing at least one CSI report may be used as the priority order between the CSI parts 2 of the at least one CSI report, where the priority order between the at least one CSI report may be determined based on the related technology.

The following describes examples of the embodiments by using different cases.

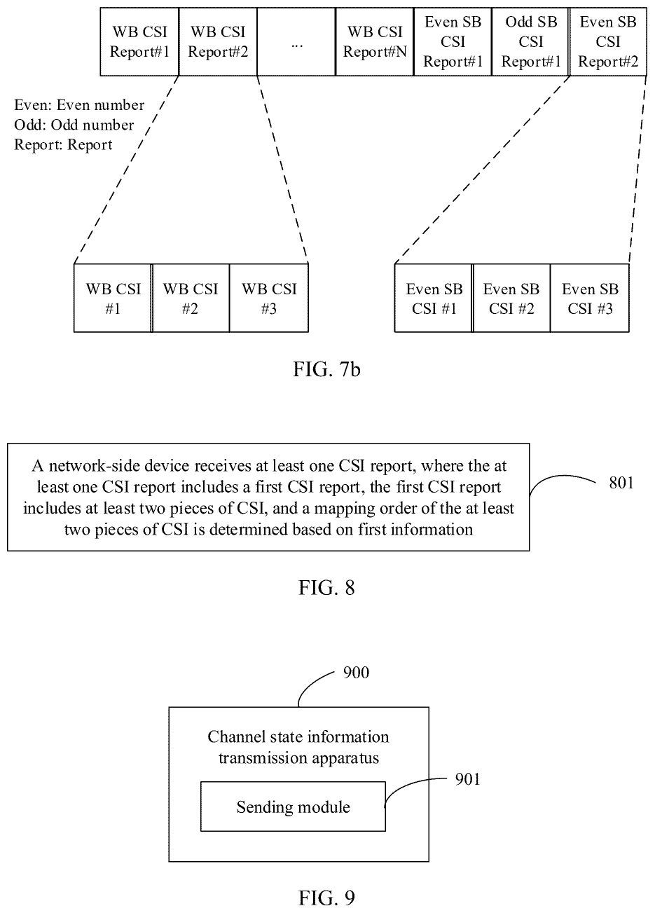

Case 1: The terminal omits or discards at least some of the CSI parts 2 of the at least two CSI reports based on a first priority relationship. To be specific, the CSI part2 is omitted or discarded at a granularity of the entire CSI report, regardless of whether the CSI report includes one piece of CSI or includes a plurality of pieces of CSI. For example, as shown in FIG. 6a, if it is determined that the mapping order or the priority order between the N CSI reports is as follows: CSI Report #1 is higher than CSI Report #2, CSI Report #2 is higher than CSI Report #3, and by analogy, . . . . CSI Report #N-1 is higher than CSI Report #N, subband CSI of a CSI part 2 of the CSI Report #N may be preferentially omitted or discarded in increasing order of the priority, as shown in FIG. 7a, or odd subband CSI of a CSI part 2 of the CSI Report #N may be preferentially omitted or discarded in increasing order of the priority, as shown in FIG. 7b.

For example, as shown in Table 16, a mapping order or a priority order between two CSI reports is as follows: CSI Report #1 is higher than CSI Report #2, even subband CSI of a plurality of pieces of CSI that belong to one CSI report is of a same priority, and odd subband CSI of a plurality of pieces of CSI that belong to one CSI report is also of a same priority. If a resource is insufficient, the UE may perform omission/discarding from a CSI report with a lowest priority, and discard SB CSI of a CSI part2 of the entire CSI report. For example, if a resource is sufficient to completely transmit SB CSI of a CSI part2 of only one CSI report, the SB CSI of the CSI part2 of the CSI report #1 may continue to be reported. As shown in Table 17, all subband CSI of the CSI part2 corresponding to all CSI of the CSI report #2 is discarded. Alternatively, the UE may perform omission/discarding from a CSI report with a lowest priority. In this embodiment, odd subband CSI of CSI #1, CSI #2, and CSI #3 whose priority is 4 has the lowest priority. Therefore, the odd subband CSI of the three pieces of CSI needs to be discarded together. In this embodiment, odd SB CSI corresponding to three pieces of CSI included in the CSI part2 of the CSI report #2 is discarded, as shown in Table 18.

TABLE 16

Priority 0:
Wideband CSI of all CSI reports
Priority 1:
Even subband CSI of CSI part2 of CSI report #1
Priority 2:
Odd subband CSI of CSI part2 of CSI report #1
Priority 3:
Even subband CSI of CSI part2 of CSI#1 of CSI report #2
Priority 3:
Even subband CSI of CSI part2 of CSI#2 of CSI report #2
Priority 3:
Even subband CSI of CSI part2 of CSI#3 of CSI report #2
Priority 4:
Odd subband CSI of CSI part2 of CSI#1 of CSI report #2
Priority 4:
Odd subband CSI of CSI part2 of CSI#2 of CSI report #2
Priority 4:
Odd subband CSI of CSI part2 of CSI#3 of CSI report #2

TABLE 17

Priority 0:
Wideband CSI of all CSI reports
Priority 1:
Even subband CSI of CSI part2 of CSI report #1
Priority 2:
Odd subband CSI of CSI part2 of CSI report #1

TABLE 18

Priority 0:
Wideband CSI of all CSI reports
Priority 1:
Even subband CSI of CSI part2 of CSI report #1
Priority 2:
Odd subband CSI of CSI part2 of CSI report #1
Priority 3:
Even subband CSI of CSI part2 of CSI#1 of CSI report #2
Priority 3:
Even subband CSI of CSI part2 of CSI#2 of CSI report #2
Priority 3:
Even subband CSI of CSI part2 of CSI#3 of CSI report #2

It can be seen from the foregoing Table 16, Table 17, and Table 18 that there are also two types of discarding at a granularity of the entire CSI report:

A first type corresponds to Table 17, in which all subband information (all odd subband CSI and even subband CSI of all CSI are discarded together) corresponding to a plurality of pieces of CSI in the CSI report is discarded or retained as a whole.

A second type corresponds to Table 18, in which for subband CSI corresponding to a plurality of pieces of CSI in the CSI report, only all odd subband CSI in the CSI report may be discarded.

Case 2: The terminal omits or discards at least some of the CSI parts 2 of the at least two CSI reports based on a first priority relationship, a second priority relationship, and a third priority relationship. To be specific, the CSI part2 is omitted or discarded at a granularity of CSI included in the CSI report. If the CSI report includes a plurality of pieces of CSI, when the CSI part2 is omitted or discarded, a CSI part2 corresponding to some CSI of the CSI report may be omitted.

For example, there are two CSI reports, that is, CSI Report #1 and CSI Report #2. The CSI Report #1 includes two pieces of CSI, the CSI Report #2 includes three pieces of CSI, and a priority order of various pieces of CSI of each CSI Report is shown in Table 19. If a resource is insufficient, the UE performs omission/discarding from a CSI part2 with a lowest priority, and may discard a CSI part2 of some CSI in a specific CSI report. As shown in Table 20, parts whose priorities are 9 and 10 are discarded, that is, only odd subband CSI corresponding to CSI #2 and CSI #3 in the CSI report #2 is discarded. Alternatively, as shown in Table 21, parts whose priorities are 4-10 are discarded, that is, for the CSI report #1, only odd subband CSI of CSI #2 in the CSI report1 #1 is discarded, and all remaining parts whose priorities are lower than the priority 1 are omitted.

TABLE 19

Priority 0:
Wideband CSI of all CSI reports
Priority 1:
Even subband CSI of CSI part2 of CSI#1 of CSI report #1
Priority 2:
Even subband CSI of CSI part2 of CSI#2 of CSI report #1
Priority 3:
Odd subband CSI of CSI part2 of CSI#1 of CSI report #1
Priority 4:
Odd subband CSI of CSI part2 of CSI#2 of CSI report #1
Priority 5:
Even subband CSI of CSI part2 of CSI#1 of CSI report #2
Priority 6:
Even subband CSI of CSI part2 of CSI#2 of CSI report #2
Priority 7:
Even subband CSI of CSI part2 of CSI#3 of CSI report #2
Priority 8:
Odd subband CSI of CSI part2 of CSI#1 of CSI report #2
Priority 9:
Odd subband CSI of CSI part2 of CSI#2 of CSI report #2
Priority 10:
Odd subband CSI of CSI part2 of CSI#3 of CSI report #2

TABLE 20

Priority 0:
Wideband CSI of all CSI reports
Priority 1:
Even subband CSI of CSI part2 of CSI#1 of CSI report #1
Priority 2:
Even subband CSI of CSI part2 of CSI#2 of CSI report #1
Priority 3:
Odd subband CSI of CSI part2 of CSI#1 of CSI report #1
Priority 4:
Odd subband CSI of CSI part2 of CSI#2 of CSI report #1
Priority 5:
Even subband CSI of CSI part2 of CSI#1 of CSI report #2
Priority 6:
Even subband CSI of CSI part2 of CSI#2 of CSI report #2
Priority 7:
Even subband CSI of CSI part2 of CSI#3 of CSI report #2
Priority 8:
Odd subband CSI of CSI part2 of CSI#1 of CSI report #2

TABLE 21

Priority 0:
Wideband CSI of all CSI reports
Priority 1:
Even subband CSI of CSI part2 of CSI#1 of CSI report #1
Priority 2:
Even subband CSI of CSI part2 of CSI#2 of CSI report #1
Priority 3:
Odd subband CSI of CSI part2 of CSI#1 of CSI report #1

In some implementations, in a case that the CSI report includes at least two pieces of CSI, the target priority further includes at least one of a fourth priority order or a fifth priority order;

the fourth priority order includes a priority order between the wideband CSI of the CSI parts 2 of all the CSI included in the CSI report, where the priority order between the wideband CSI of the CSI parts 2 of all the CSI included in the CSI report is determined based on a second mapping order;

the fifth priority order includes a priority order between the subband CSI of the CSI parts 2 of all the CSI included in the CSI report, where the priority order between the subband CSI of the CSI parts 2 of all the CSI included in the CSI report is determined based on the second mapping order;

or the fifth priority order includes a priority order between even subband CSI of the CSI parts 2 of all the CSI included in the CSI report, and a priority order between odd subband CSI of the CSI parts 2 of all the CSI included in the CSI report, where priorities of the even subband CSI of the CSI parts 2 of all the CSI included in the CSI report are the same, or priorities of the even subband CSI of the CSI parts 2 of all the CSI included in the CSI report are determined based on the second mapping order; and priorities of the odd subband CSI of the CSI parts 2 of all the CSI included in the CSI report are the same, or priorities of the odd subband CSI of the CSI parts 2 of all the CSI included in the CSI report are determined based on the second mapping order; and the second mapping order is a mapping order determined based on the first information.

In an implementation, for a CSI report that includes at least two pieces of CSI, subband CSI of a CSI part 2 of each piece of CSI in the CSI report may be mapped as a whole, for example, as shown in FIG. 6a or FIG. 6b.

In another implementation, for a CSI report that includes at least two pieces of CSI, even subband CSI and odd subband CSI of a CSI part 2 of each piece of CSI in the CSI report are separately mapped, as shown in FIG. 4 or FIG. 5.

In this implementation, even subband CSI of CSI parts 2 of a plurality of pieces of CSI included in each CSI report may have a same priority, and odd subband CSI of CSI parts 2 of a plurality of pieces of CSI included in each CSI report may have a same priority, for example, as shown in Table 16. Alternatively, a priority order between the priorities of the even subband CSI of the CSI parts 2 of the plurality of pieces of CSI included in each CSI report may be determined based on a second mapping order, and a priority order between the priorities of the odd subband CSI of the CSI parts 2 of the plurality of pieces of CSI included in each CSI report may also be determined based on the second mapping order, as shown in Table 19.

In some implementations, the omitting or discarding, by the terminal, at least some of the CSI parts 2 of the at least one CSI report based on a target priority order includes:
omitting or discarding, by the terminal, the CSI parts 2 of the at least one CSI report successively in increasing order of priorities based on the target priority order, until a code rate of the CSI parts 2 is less than or equal to a first preset value.

In this embodiment, the foregoing first preset value may be a maximum code rate (maxCodeRate) configured by a higher layer.

In some implementations, the at least one CSI report is carried on a physical uplink control channel PUCCH, and each of the CSI report includes only a CSI part 1; and
the method further includes:
in a case that there are at least two to-be-sent CSI reports on the PUCCH, omitting or discarding, by the terminal, some of the at least two CSI reports based on a priority order between the at least two CSI reports.

In this embodiment, in a case that at least two CSI reports need to be sent on the PUCCH, the terminal may omit or discard some of the at least two CSI reports based on a priority order between the at least two CSI reports.

For example, in a case that there are two CSI reports (that is, CSI Report #1 and CSI Report #2) on the PUCCH, where a priority of the CSI Report #1 is higher than a priority of the CSI Report #2, if a resource is insufficient, the UE preferentially omits or discards the CSI Report #2. To be specific, all CSI of the CSI Report #2 is omitted or discarded.

In some implementations, the discarding, by the terminal, some of the at least two CSI reports based on a priority order between the at least two CSI reports includes:
omitting or discarding, by the terminal, the CSI reports in the at least two CSI reports successively in increasing order of priorities, until a code rate of the CSI reports is less than or equal to a second preset value.

In this embodiment, the foregoing second preset value may be a maximum code rate (maxCodeRate) configured by a higher layer.

In some implementations, the terminal successively omits or discards the CSI reports in the at least two CSI reports in increasing order of the priority based on the priority order between the at least two CSI reports.

Referring to FIG. 8, FIG. 8 is a flowchart of a channel state information transmission method according to an embodiment of this application. The method may be performed by a network-side device. As shown in FIG. 8, the method includes the following steps.

Step 801: A network-side device receives at least one CSI report.

The at least one CSI report includes a first CSI report, the first CSI report includes at least two pieces of CSI, a mapping order of the at least two pieces of CSI is determined based on first information, and the first information includes at least one of the following: second information associated with each of the at least two pieces of CSI, reported content of each of the at least two pieces of CSI, or an order of at least two spatial adaptation patterns or an order of at least two sub-configurations configured or indicated by a network-side device.

The at least two spatial adaptation patterns or the at least two sub-configurations are in a one-to-one correspondence with the at least two pieces of CSI, and the second information includes at least one of the following: a sub-configuration identifier, a spatial adaptation pattern identifier, a resource-related identifier, a codebook configuration identifier, a code division multiplexing group identifier, a code division multiplexing group quantity, a port quantity, a power offset, or a first quantity.

The first quantity is related to at least one of the following: a quantity of antenna ports in a horizontal direction of one polarization direction on one panel, a quantity of antenna ports in a vertical direction of one polarization direction on one panel, or a quantity of antenna panels.

In some implementations, the resource-related identifier includes at least one of the following:
channel state information reference signal CSI-RS resource group identifier, CSI-RS resource set identifier, or CSI-RS resource identifier.

In some implementations, the first quantity is one of the following:
N1, N2, Ng, N1*N2, N1*N2*Ng, or N1*N2*O1*O2, where
N1 is the quantity of antenna ports in the horizontal direction of one polarization direction on one panel, N2 is the quantity of antenna ports in the vertical direction of one polarization direction on one panel, Ng is the quantity of antenna panels, O1 is an over-sampling multiple in the horizontal direction, and O2 is an over-sampling multiple in the vertical direction.

In some implementations, the at least two pieces of CSI are mapped in decreasing order of the second information, or the at least two pieces of CSI are mapped in increasing order of the second information.

In some implementations, a mapping order of first CSI precedes a mapping order of second CSI; or
a mapping order of first CSI follows a mapping order of second CSI;
the first CSI is CSI with some CSI fields being omitted from the reported content in the at least two pieces of CSI; or
the first CSI is CSI with CSI field sharing in reported content in the at least two pieces of CSI; and
the second CSI is CSI except the first CSI in the at least two pieces of CSI.

In some implementations, in a case that there are at least two pieces of first CSI, a mapping order of the at least two pieces of first CSI is determined based on at least one of the following: second information associated with each of the at least two pieces of first CSI, or an order of at least two first spatial adaptation patterns or at least two first sub-configurations configured or indicated by the network-side device, where the at least two first spatial adaptation patterns or the at least two first sub-configurations are in a one-to-one correspondence with the at least two pieces of first CSI;
or
in a case that there are at least two pieces of second CSI, a mapping order of the at least two pieces of second CSI is determined based on at least one of the following: second information associated with each of the at least two pieces of second CSI, or an order of at least two second spatial adaptation patterns or at least two second sub-configurations configured or indicated by the network-side device, where the at least two second spatial adaptation patterns or the at least two second sub-configurations are in a one-to-one correspondence with the at least two pieces of second CSI.

In some implementations, the spatial adaptation pattern or the sub-configuration includes at least one of the following:
a spatial adaptation pattern identifier;
a sub-configuration identifier;
a CSI-RS resource group identifier;
a CSI-RS resource identifier;
a port quantity;
a port subset;
a power offset;
a quantity of antenna ports in a horizontal direction of a single polarization direction on each panel;
a quantity of antenna ports in a vertical direction of a single polarization direction on each panel;
a quantity of antenna ports;
reported content of CSI; or
a codebook configuration.

In some implementations, the port subset includes at least one of the following: a port subset identifier or a CDM group identifier.

In some implementations, the codebook configuration includes at least one of the following: a codebook configuration identifier, a codebook subset restriction CBSR parameter, a rank indication RI restriction parameter, or a codebook type.

In some implementations, the first CSI report further includes third information, and the third information is used to assist the network-side device in confirming content of the first CSI report.

In some implementations, the third information includes at least one of the following:
a quantity of pieces of CSI included in the first CSI report;
a quantity of sub-configurations associated with the CSI included in the first CSI report;
a quantity of spatial adaptation patterns associated with the CSI included in the first CSI report;
a CSI-RS resource indicator CRI associated with the CSI included in the first CSI report;
a CSI-RS resource group identifier associated with the CSI included in the first CSI report;
a CSI-RS resource identifier associated with the CSI included in the first CSI report;
a spatial adaptation pattern identifier associated with the CSI included in the first CSI report; or
a sub-configuration identifier associated with the CSI included in the first CSI report.

In some implementations, a mapping order of the third information precedes the mapping order of the at least two pieces of CSI.

In some implementations, the third information is located in a CSI part 1 of the first CSI report.

In some implementations, a quantity of loads of the CSI part 1 is a fixed value.

In some implementations, the quantity of loads of the CSI part 1 is related to at least one of the following: the quantity of pieces of CSI included in the first CSI report, or CSI reporting capability information of a terminal; and
the CSI reporting capability information is used to indicate a maximum quantity of pieces of CSI that the terminal supports reporting in the same CSI report.

In some implementations, a CSI part 1 of each piece of CSI included in the first CSI report includes the third information.

In some implementations, a subband differential channel quality indicator CQI of a first transport block of each of the at least two pieces of CSI is separately located in a CSI part 2 of the piece of CSI.

In some implementations, in a case that the at least two pieces of CSI include third CSI, a CSI part 2 of the third CSI includes only wideband CSI; and
the third CSI is CSI with CSI field sharing in reported content in the at least two pieces of CSI.

In some implementations, the CSI part 1 of the first CSI report includes CSI parts 1 of the at least two pieces of CSI, and the CSI parts 1 of the at least two pieces of CSI are arranged in a first mapping order;
or
a CSI part 2 of the first CSI report includes CSI parts 2 of the at least two pieces of CSI, and the CSI parts 2 of the at least two pieces of CSI are arranged in the first mapping order, where
the first mapping order is the mapping order, determined based on the first information, of the at least two pieces of CSI.

In some implementations, wideband CSI of each of the CSI parts 2 of the at least two pieces of CSI is arranged in front of subband CSI of each of the CSI parts 2 of the at least two pieces of CSI, and the wideband CSI of the CSI parts 2 of the at least two pieces of CSI is arranged in the first mapping order.

In some implementations, even subband CSI of each of the CSI parts 2 of the at least two pieces of CSI is arranged in front of odd subband CSI of each of the CSI parts 2 of the at least two pieces of CSI, the even subband CSI of the CSI parts 2 of the at least two pieces of CSI is arranged in the first mapping order, and the odd subband CSI of the CSI parts 2 of the at least two pieces of CSI is arranged in the first mapping order;
or
the subband CSI of the CSI parts 2 of the at least two pieces of CSI is arranged in the first mapping order, and even subband CSI of a CSI part 2 of each of the at least two pieces of CSI is separately arranged in front of odd subband CSI of the CSI part 2 of the piece of CSI.

It should be noted that for an implementation of this implementation, reference may be made to related descriptions of the embodiment shown in FIG. 3. Details are not described herein again.

It should be noted that the channel state information transmission method provided in the embodiments of this application may be performed by a channel state information transmission apparatus, or by a control module, configured to perform the channel state information transmission method, in the channel state information transmission apparatus. In the embodiments of this application, the channel state information transmission apparatus provided in the embodiments of this application is described by using an example in which the channel state information transmission apparatus performs the channel state information transmission method.

Referring to FIG. 9, FIG. 9 is a structural diagram of a channel state information transmission apparatus according to an embodiment of this application. As shown in FIG. 9, the channel state information transmission apparatus 900 includes:
a sending module 901, configured to send at least one channel state information CSI report, where
the at least one CSI report includes a first CSI report, the first CSI report includes at least two pieces of CSI, a mapping order of the at least two pieces of CSI is determined based on first information, and the first information includes at least one of the following: second information associated with each of the at least two pieces of CSI, reported content of each of the at least two pieces of CSI, or an order of at least two spatial adaptation patterns or an order of at least two sub-configurations configured or indicated by a network-side device;
the at least two spatial adaptation patterns or the at least two sub-configurations are in a one-to-one correspondence with the at least two pieces of CSI, and the second information includes at least one of the following: a sub-configuration identifier, a spatial adaptation pattern identifier, a resource-related identifier, a codebook configuration identifier, a code division multiplexing group identifier, a code division multiplexing group quantity, a port quantity, a power offset, or a first quantity; and
the first quantity is related to at least one of the following: a quantity of antenna ports in a horizontal direction of one polarization direction on one panel, a quantity of antenna ports in a vertical direction of one polarization direction on one panel, or a quantity of antenna panels.

In some implementations, the resource-related identifier includes at least one of the following:
channel state information reference signal CSI-RS resource group identifier, CSI-RS resource set identifier, or CSI-RS resource identifier.

In some implementations, the first quantity is one of the following:
N1, N2, Ng, N1*N2, N1*N2*Ng, or N1*N2*O1*O2, where
N1 is the quantity of antenna ports in the horizontal direction of one polarization direction on one panel, N2 is the quantity of antenna ports in the vertical direction of one polarization direction on one panel, Ng is the quantity of antenna panels, O1 is an over-sampling multiple in the horizontal direction, and O2 is an over-sampling multiple in the vertical direction.

In some implementations, the at least two pieces of CSI are mapped in decreasing order of the second information, or the at least two pieces of CSI are mapped in increasing order of the second information.

In some implementations, a mapping order of first CSI precedes a mapping order of second CSI; or
a mapping order of first CSI follows a mapping order of second CSI;
the first CSI is CSI with some CSI fields being omitted from the reported content in the at least two pieces of CSI; or
the first CSI is CSI with CSI field sharing in reported content in the at least two pieces of CSI; and
the second CSI is CSI except the first CSI in the at least two pieces of CSI.

In some implementations, in a case that there are at least two pieces of first CSI, a mapping order of the at least two pieces of first CSI is determined based on at least one of the following: second information associated with each of the at least two pieces of first CSI, or an order of at least two first spatial adaptation patterns or at least two first sub-configurations configured or indicated by the network-side device, where the at least two first spatial adaptation patterns or the at least two first sub-configurations are in a one-to-one correspondence with the at least two pieces of first CSI;
or
in a case that there are at least two pieces of second CSI, a mapping order of the at least two pieces of second CSI is determined based on at least one of the following: second information associated with each of the at least two pieces of second CSI, or an order of at least two second spatial adaptation patterns or at least two second sub-configurations configured or indicated by the network-side device, where the at least two second spatial adaptation patterns or the at least two second sub-configurations are in a one-to-one correspondence with the at least two pieces of second CSI.

In some implementations, the spatial adaptation pattern or the sub-configuration includes at least one of the following:
a spatial adaptation pattern identifier;
a sub-configuration identifier;
a CSI-RS resource group identifier;
a CSI-RS resource identifier;
a port quantity;
a port subset;
a power offset;
a quantity of antenna ports in a horizontal direction of a single polarization direction on each panel;
a quantity of antenna ports in a vertical direction of a single polarization direction on each panel;
a quantity of antenna ports;
reported content of CSI; or
a codebook configuration.

In some implementations, the port subset includes at least one of the following: a port subset identifier or a CDM group identifier.

In some implementations, the codebook configuration includes at least one of the a rank indication RI restriction parameter, or a codebook type.

In some implementations, the first CSI report further includes third information, and the third information is used to assist the network-side device in confirming content of the first CSI report.

In some implementations, the third information includes at least one of the following:
a quantity of pieces of CSI included in the first CSI report;
a quantity of sub-configurations associated with the CSI included in the first CSI report;
a quantity of spatial adaptation patterns associated with the CSI included in the first CSI report;
a CSI-RS resource indicator CRI associated with the CSI included in the first CSI report;
a CSI-RS resource group identifier associated with the CSI included in the first CSI report;
a CSI-RS resource identifier associated with the CSI included in the first CSI report;
a spatial adaptation pattern identifier associated with the CSI included in the first CSI report; or
a sub-configuration identifier associated with the CSI included in the first CSI report.

In some implementations, a mapping order of the third information precedes the mapping order of the at least two pieces of CSI.

In some implementations, the third information is located in a CSI part 1 of the first CSI report.

In some implementations, a quantity of loads of the CSI part 1 is a fixed value.

In some implementations, the quantity of loads of the CSI part 1 is related to at least one of the following: the quantity of pieces of CSI included in the first CSI report, or CSI reporting capability information of the terminal; and
the CSI reporting capability information is used to indicate a maximum quantity of pieces of CSI that the terminal supports reporting in the same CSI report.

In some implementations, a CSI part 1 of each piece of CSI included in the first CSI report includes the third information.

In some implementations, a subband differential channel quality indicator CQI of a first transport block of each of the at least two pieces of CSI is separately located in a CSI part 2 of the piece of CSI.

In some implementations, in a case that the at least two pieces of CSI include third CSI, a CSI part 2 of the third CSI includes only wideband CSI; and
the third CSI is CSI with CSI field sharing in reported content in the at least two pieces of CSI.

In some implementations, the CSI part 1 of the first CSI report includes CSI parts 1 of the at least two pieces of CSI, and the CSI parts 1 of the at least two pieces of CSI are arranged in a first mapping order;
or
a CSI part 2 of the first CSI report includes CSI parts 2 of the at least two pieces of CSI, and the CSI parts 2 of the at least two pieces of CSI are arranged in the first mapping order, where
the first mapping order is the mapping order, determined based on the first information, of the at least two pieces of CSI.

In some implementations, wideband CSI of each of the CSI parts 2 of the at least two pieces of CSI is arranged in front of subband CSI of each of the CSI parts 2 of the at least two pieces of CSI, and the wideband CSI of the CSI parts 2 of the at least two pieces of CSI is arranged in the first mapping order.

In some implementations, even subband CSI of each of the CSI parts 2 of the at least two pieces of CSI is arranged in front of odd subband CSI of each of the CSI parts 2 of the at least two pieces of CSI, the even subband CSI of the CSI parts 2 of the at least two pieces of CSI is arranged in the first mapping order, and the odd subband CSI of the CSI parts 2 of the at least two pieces of CSI is arranged in the first mapping order;
or
the subband CSI of the CSI parts 2 of the at least two pieces of CSI is arranged in the first mapping order, and even subband CSI of a CSI part 2 of each of the at least two pieces of CSI is separately arranged in front of odd subband CSI of the CSI part 2 of the piece of CSI.

In some implementations, the apparatus further includes:
a first processing module, configured to: in a case that each of the at least one CSI report includes a CSI part 1 and a CSI part 2, omit or discard at least some of the CSI parts 2 of the at least one CSI report based on a target priority order, where
the target priority order includes at least one of a first priority order, a second priority order, or a third priority order;
the first priority order includes a priority order between the CSI parts 2 of the at least one CSI report;
the second priority order includes: a priority of wideband CSI of each of CSI parts 2 of all CSI included in each of the at least one CSI report is separately higher than a priority of subband CSI of each of the CSI parts 2 of all the CSI included in the CSI report; and
the third priority order includes: a priority of even subband CSI of a CSI part 2 of each piece of CSI included in each CSI report is separately higher than a priority of odd subband CSI of the CSI part 2 of the piece of CSI included in the CSI report, or a priority of even subband CSI of each of CSI parts 2 of all CSI included in each CSI report is separately higher than a priority of odd subband CSI of each of the CSI parts 2 of all the CSI included in the CSI report.

In some implementations, in a case that the CSI report includes at least two pieces of CSI, the target priority further includes at least one of a fourth priority order or a fifth priority order;
the fourth priority order includes a priority order between the wideband CSI of the CSI parts 2 of all the CSI included in the CSI report, where the priority order between the wideband CSI of the CSI parts 2 of all the CSI included in the CSI report is determined based on a second mapping order;
the fifth priority order includes a priority order between the subband CSI of the CSI parts 2 of all the CSI included in the CSI report, where the priority order between the subband CSI of the CSI parts 2 of all the CSI included in the CSI report is determined based on the second mapping order;
or
the fifth priority order includes a priority order between even subband CSI of the CSI parts 2 of all the CSI included in the CSI report, and a priority order between odd subband CSI of the CSI parts 2 of all the CSI included in the CSI report, where priorities of the even subband CSI of the CSI parts 2 of all the CSI included in the CSI report are the same, or priorities of the even subband CSI of the CSI parts 2 of all the CSI included in the CSI report are determined based on the second mapping order; and priorities of the odd subband CSI of the CSI parts 2 of all the CSI included in the CSI report are the same, or priorities of the odd subband CSI of the CSI parts 2 of all the CSI included in the CSI report are determined based on the second mapping order; and
the second mapping order is a mapping order determined based on the first information.

In some implementations, the first processing module is configured to:
omit or discard the CSI parts 2 of the at least one CSI report successively in increasing order of priorities based on the target priority order, until a code rate of the CSI parts 2 is less than or equal to a first preset value.

In some implementations, the at least one CSI report is carried on a physical uplink control channel PUCCH, and each of the CSI report includes only a CSI part 1; and
the apparatus further includes:
a second processing module, configured to: in a case that there are at least two to-be-sent CSI reports on the PUCCH, omit or discard some of the at least two CSI reports based on a priority order between the at least two CSI reports.

In some implementations, the second processing module is configured to:
omit or discard the CSI reports in the at least two CSI reports successively in increasing order of priorities, until a code rate of the CSI reports is less than or equal to a second preset value.

The channel state information transmission apparatus in the embodiments of this application may be an electronic device, for example, an electronic device with an operating system; or may be a component in an electronic device, for example, an integrated circuit or a chip. The electronic device may be a terminal, or may be another device other than the terminal. For example, the terminal may include but is not limited to the foregoing listed types of the terminal 11. The another device may be a server, a Network Attached Storage (NAS), or the like. This is not specifically limited in the embodiments of this application.

The channel state information transmission apparatus provided in the embodiments of this application can implement processes implemented in the method embodiment shown in FIG. 3, and achieve the same technical effect. To avoid repetition, details are not described herein again.

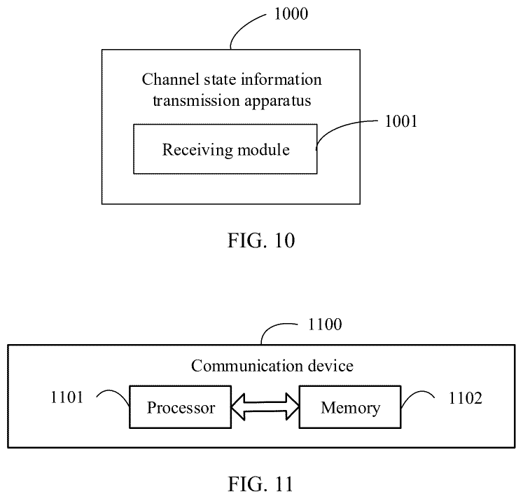

Referring to FIG. 10, FIG. 10 is a structural diagram of a channel state information transmission apparatus according to an embodiment of this application. As shown in FIG. 10, the channel state information transmission apparatus 1000 includes:
a receiving module 1001, configured to receive at least one channel state information CSI report, where
the at least one CSI report includes a first CSI report, the first CSI report includes at least two pieces of CSI, a mapping order of the at least two pieces of CSI is determined based on first information, and the first information includes at least one of the following: second information associated with each of the at least two pieces of CSI, reported content of each of the at least two pieces of CSI, or an order of at least two spatial adaptation patterns or an order of at least two sub-configurations configured or indicated by a network-side device;
the at least two spatial adaptation patterns or the at least two sub-configurations are in a one-to-one correspondence with the at least two pieces of CSI, and the second information includes at least one of the following: a sub-configuration identifier, a spatial adaptation pattern identifier, a resource-related identifier, a codebook configuration identifier, a code division multiplexing group identifier, a code division multiplexing group quantity, a port quantity, a power offset, or a first quantity; and
the first quantity is related to at least one of the following: a quantity of antenna ports in a horizontal direction of one polarization direction on one panel, a quantity of antenna ports in a vertical direction of one polarization direction on one panel, or a quantity of antenna panels.

In some implementations, the resource-related identifier includes at least one of the following:
channel state information reference signal CSI-RS resource group identifier, CSI-RS resource set identifier, or CSI-RS resource identifier.

In some implementations, the first quantity is one of the following:
N1, N2, Ng, N1*N2, N1*N2*Ng, or N1*N2*O1*O2, where
N1 is the quantity of antenna ports in the horizontal direction of one polarization direction on one panel, N2 is the quantity of antenna ports in the vertical direction of one polarization direction on one panel, Ng is the quantity of antenna panels, O1 is an over-sampling multiple in the horizontal direction, and O2 is an over-sampling multiple in the vertical direction.

In some implementations, the at least two pieces of CSI are mapped in decreasing order of the second information, or the at least two pieces of CSI are mapped in increasing order of the second information.

In some implementations, a mapping order of first CSI precedes a mapping order of second CSI; or
a mapping order of first CSI follows a mapping order of second CSI;
the first CSI is CSI with some CSI fields being omitted from the reported content in the at least two pieces of CSI; or
the first CSI is CSI with CSI field sharing in reported content in the at least two pieces of CSI; and
the second CSI is CSI except the first CSI in the at least two pieces of CSI.

In some implementations, in a case that there are at least two pieces of first CSI, a mapping order of the at least two pieces of first CSI is determined based on at least one of the following: second information associated with each of the at least two pieces of first CSI, or an order of at least two first spatial adaptation patterns or at least two first sub-configurations configured or indicated by the network-side device, where the at least two first spatial adaptation patterns or the at least two first sub-configurations are in a one-to-one correspondence with the at least two pieces of first CSI;
or
in a case that there are at least two pieces of second CSI, a mapping order of the at least two pieces of second CSI is determined based on at least one of the following: second information associated with each of the at least two pieces of second CSI, or an order of at least two second spatial adaptation patterns or at least two second sub-configurations configured or indicated by the network-side device, where the at least two second spatial adaptation patterns or the at least two second sub-configurations are in a one-to-one correspondence with the at least two pieces of second CSI.

In some implementations, the spatial adaptation pattern or the sub-configuration includes at least one of the following:
a spatial adaptation pattern identifier;
a sub-configuration identifier;
a CSI-RS resource group identifier;
a CSI-RS resource identifier;
a port quantity;
a port subset;
a power offset;
a quantity of antenna ports in a horizontal direction of a single polarization direction on each panel;
a quantity of antenna ports in a vertical direction of a single polarization direction on each panel;
a quantity of antenna ports;
reported content of CSI; or
a codebook configuration.

In some implementations, the port subset includes at least one of the following: a port subset identifier or a CDM group identifier.

In some implementations, the codebook configuration includes at least one of the a rank indication RI restriction parameter, or a codebook type.

In some implementations, the first CSI report further includes third information, and the third information is used to assist the network-side device in confirming content of the first CSI report.

In some implementations, the third information includes at least one of the following:
a quantity of pieces of CSI included in the first CSI report;
a quantity of sub-configurations associated with the CSI included in the first CSI report;
a quantity of spatial adaptation patterns associated with the CSI included in the first CSI report;
a CSI-RS resource indicator CRI associated with the CSI included in the first CSI report;
a CSI-RS resource group identifier associated with the CSI included in the first CSI report;
a CSI-RS resource identifier associated with the CSI included in the first CSI report;
a spatial adaptation pattern identifier associated with the CSI included in the first CSI report; or
a sub-configuration identifier associated with the CSI included in the first CSI report.

In some implementations, a mapping order of the third information precedes the mapping order of the at least two pieces of CSI.

In some implementations, the third information is located in a CSI part 1 of the first CSI report.

In some implementations, a quantity of loads of the CSI part 1 is a fixed value.

In some implementations, the quantity of loads of the CSI part 1 is related to at least one of the following: the quantity of pieces of CSI included in the first CSI report, or CSI reporting capability information of a terminal; and
the CSI reporting capability information is used to indicate a maximum quantity of pieces of CSI that the terminal supports reporting in the same CSI report.

In some implementations, a CSI part 1 of each piece of CSI included in the first CSI report includes the third information.

In some implementations, a subband differential channel quality indicator CQI of a first transport block of each of the at least two pieces of CSI is separately located in a CSI part 2 of the piece of CSI.

In some implementations, in a case that the at least two pieces of CSI include third CSI, a CSI part 2 of the third CSI includes only wideband CSI; and
the third CSI is CSI with CSI field sharing in reported content in the at least two pieces of CSI.

In some implementations, the CSI part 1 of the first CSI report includes CSI parts 1 of the at least two pieces of CSI, and the CSI parts 1 of the at least two pieces of CSI are arranged in a first mapping order;
or
a CSI part 2 of the first CSI report includes CSI parts 2 of the at least two pieces of CSI, and the CSI parts 2 of the at least two pieces of CSI are arranged in the first mapping order, where
the first mapping order is the mapping order, determined based on the first information, of the at least two pieces of CSI.

In some implementations, wideband CSI of each of the CSI parts 2 of the at least two pieces of CSI is arranged in front of subband CSI of each of the CSI parts 2 of the at least two pieces of CSI, and the wideband CSI of the CSI parts 2 of the at least two pieces of CSI is arranged in the first mapping order.

In some implementations, even subband CSI of each of the CSI parts 2 of the at least two pieces of CSI is arranged in front of odd subband CSI of each of the CSI parts 2 of the at least two pieces of CSI, the even subband CSI of the CSI parts 2 of the at least two pieces of CSI is arranged in the first mapping order, and the odd subband CSI of the CSI parts 2 of the at least two pieces of CSI is arranged in the first mapping order;
or
the subband CSI of the CSI parts 2 of the at least two pieces of CSI is arranged in the first mapping order, and even subband CSI of a CSI part 2 of each of the at least two pieces of CSI is separately arranged in front of odd subband CSI of the CSI part 2 of the piece of CSI.

The channel state information transmission apparatus in the embodiments of this application may be an electronic device, for example, an electronic device with an operating system; or may be a component in an electronic device, for example, an integrated circuit or a chip. The electronic device may be a network-side device, or may be another device other than the network-side device. For example, the network-side device may include but is not limited to the types of the network-side device 12 listed above, and the another device may be a server, a Network Attached Storage (NAS), or the like. This is not specifically limited in the embodiments of this application.

The channel state information transmission apparatus provided in the embodiments of this application can implement processes implemented in the method embodiment shown in FIG. 8, and achieve the same technical effect. To avoid repetition, details are not described herein again.

In some implementations, as shown in FIG. 11, an embodiment of this application further provides a communication device 1100, including a processor 1101 and a memory 1102. The memory 1102 stores a program or instructions capable of running on the processor 1101. For example, when the communication device 1100 is a terminal, the program or the instructions are executed by the processor 1101 to implement the steps in the embodiment of the channel state information transmission method on the terminal side, and the same technical effects can be achieved. When the communication device 1100 is a network-side device, the program or the instructions are executed by the processor 1101 to implement the steps in the embodiment of the channel state information transmission method on the network-side device side, and the same technical effects can be achieved. To avoid repetition, details are not described herein again.

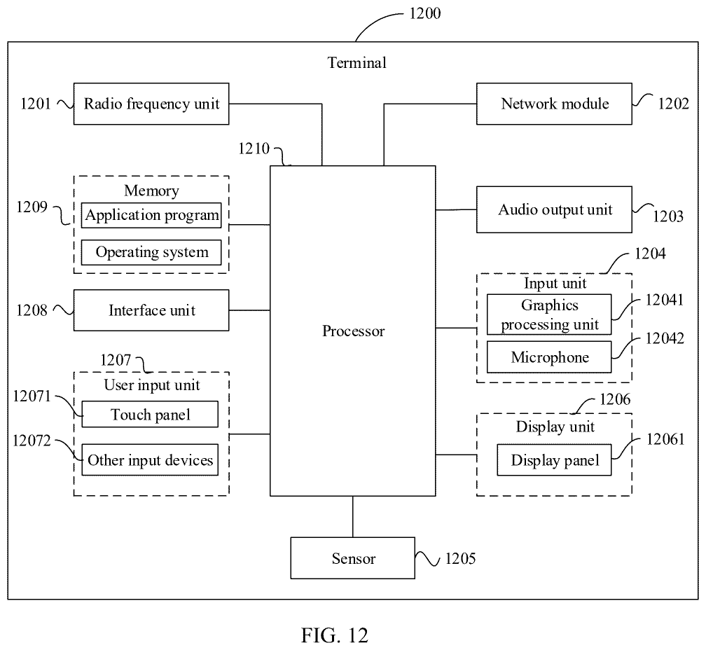

An embodiment of this application further provides a terminal. The terminal includes a processor and a communication interface, where the communication interface is configured to send at least one channel state information CSI report. The at least one CSI report includes a first CSI report, the first CSI report includes at least two pieces of CSI, a mapping order of the at least two pieces of CSI is determined based on first information, and the first information includes at least one of the following: second information associated with each of the at least two pieces of CSI, reported content of each of the at least two pieces of CSI, or an order of at least two spatial adaptation patterns or an order of at least two sub-configurations configured or indicated by a network-side device. The at least two spatial adaptation patterns or the at least two sub-configurations are in a one-to-one correspondence with the at least two pieces of CSI, and the second information includes at least one of the following: a sub-configuration identifier, a spatial adaptation pattern identifier, a resource-related identifier, a codebook configuration identifier, a code division multiplexing group identifier, a code division multiplexing group quantity, a port quantity, a power offset, or a first quantity. The first quantity is related to at least one of the following: a quantity of antenna ports in a horizontal direction of one polarization direction on one panel, a quantity of antenna ports in a vertical direction of one polarization direction on one panel, or a quantity of antenna panels. The terminal embodiment corresponds to the foregoing terminal-side method embodiment. Each implementation process and implementation of the foregoing method embodiment may be applied to the terminal embodiment, and the same technical effects can be achieved. In some implementations, FIG. 12 is a schematic diagram of a hardware structure of a terminal for implementing an embodiment of this application.

The terminal 1200 includes but is not limited to at least some components of a radio frequency unit 1201, a network module 1202, an audio output unit 1203, an input unit 1204, a sensor 1205, a display unit 1206, a user input unit 1207, an interface unit 1208, a memory 1209, a processor 1210, and the like.

A person skilled in the art may understand that the terminal 1200 may further include a power supply (for example, a battery) that supplies power to each component. The power supply may be logically connected to the processor 1210 by using a power management system, to implement functions such as charging management, discharging management, and power consumption management through the power management system. The structure of the terminal shown in FIG. 12 does not constitute a limitation on the terminal. The terminal may include more or fewer components than those shown in the figure, or combine some components, or have different component arrangements. Details are not described herein again.

It should be understood that in this embodiment of this application, the input unit 1204 may include a graphics processing unit (Graphics Processing Unit, GPU) 12041 and a microphone 12042, and the graphics processing unit 12041 processes image data of a still picture or a video obtained by an image capture apparatus (for example, a camera) in a video capture mode or an image capture mode. The display unit 1206 may include a display panel 12061, and the display panel 12061 may be configured in a form of a liquid crystal display, an organic light-emitting diode, or the like. The user input unit 1207 includes at least one of a touch panel 12071 or other input devices 12072. The touch panel 12071 is also referred to as a touchscreen. The touch panel 12071 may include two parts: a touch detection apparatus and a touch controller. The other input devices 12072 may include but are not limited to a physical keyboard, a function key (such as a volume control key or an on/off key), a trackball, a mouse, and a joystick. Details are not described herein again.

In this embodiment of this application, after receiving downlink data from a network-side device, the radio frequency unit 1201 may transmit the downlink data to the processor 1210 for processing. In addition, the radio frequency unit 1201 may send uplink data to the network-side device. Generally, the radio frequency unit 1201 includes but is not limited to an antenna, an amplifier, a transceiver, a coupler, a low-noise amplifier, a duplexer, and the like.

The memory 1209 may be configured to store a software program or instructions and various types of data. The memory 1209 may mainly include a first storage area for storing a program or instructions and a second storage area for storing data. The first storage area may store an operating system, an application program or instructions required by at least one function (for example, a sound playing function and an image playing function), and the like. In addition, the memory 1209 may include a volatile memory or a nonvolatile memory. The volatile memory may be a Random Access Memory (RAM), a Static Random Access Memory (SRAM), a Dynamic Random Access Memory (DRAM), a Synchronous Dynamic Random Access Memory (SDRAM), a Double Data Rate Synchronous Dynamic Random Access Memory (DDR SDRAM), an Enhanced Synchronous Dynamic Random Access Memory (ESDRAM), a SynchLink Dynamic Random Access Memory (SLDRAM), or a Direct Rambus Random Access Memory (DRRAM). The memory 1209 in this embodiment of this application includes but is not limited to these memories and any other suitable type of memory.

The processor 1210 may include one or more processing units. In some implementations, the processor 1210 integrates an application processor and a modem processor. The application processor mainly processes operations related to an operating system, a user interface, an application program, and the like. The modem processor mainly processes a wireless communication signal, such as a baseband processor. It may be understood that, the foregoing modem processor may not be integrated into the processor 1210.

The radio frequency unit 1201 is configured to send at least one channel state information CSI report. The at least one CSI report includes a first CSI report, the first CSI report includes at least two pieces of CSI, a mapping order of the at least two pieces of CSI is determined based on first information, and the first information includes at least one of the following: second information associated with each of the at least two pieces of CSI, reported content of each of the at least two pieces of CSI, or an order of at least two spatial adaptation patterns or an order of at least two sub-configurations configured or indicated by a network-side device. The at least two spatial adaptation patterns or the at least two sub-configurations are in a one-to-one correspondence with the at least two pieces of CSI, and the second information includes at least one of the following: a sub-configuration identifier, a spatial adaptation pattern identifier, a resource-related identifier, a codebook configuration identifier, a code division multiplexing group identifier, a code division multiplexing group quantity, a port quantity, a power offset, or a first quantity. The first quantity is related to at least one of the following: a quantity of antenna ports in a horizontal direction of one polarization direction on one panel, a quantity of antenna ports in a vertical direction of one polarization direction on one panel, or a quantity of antenna panels.

It may be understood that for implementation processes of the implementations mentioned in this embodiment, reference may be made to the related descriptions in the foregoing method embodiment, and same or corresponding technical effects are achieved. To avoid repetition, details are not described herein again.

An embodiment of this application further provides a network-side device. The network-side device includes a processor and a communication interface, where the communication interface is configured to receive at least one channel state information CSI report. The at least one CSI report includes a first CSI report, the first CSI report includes at least two pieces of CSI, a mapping order of the at least two pieces of CSI is determined based on first information, and the first information includes at least one of the following: second information associated with each of the at least two pieces of CSI, reported content of each of the at least two pieces of CSI, or an order of at least two spatial adaptation patterns or an order of at least two sub-configurations configured or indicated by a network-side device. The at least two spatial adaptation patterns or the at least two sub-configurations are in a one-to-one correspondence with the at least two pieces of CSI, and the second information includes at least one of the following: a sub-configuration identifier, a spatial adaptation pattern identifier, a resource-related identifier, a codebook configuration identifier, a code division multiplexing group identifier, a code division multiplexing group quantity, a port quantity, a power offset, or a first quantity. The first quantity is related to at least one of the following: a quantity of antenna ports in a horizontal direction of one polarization direction on one panel, a quantity of antenna ports in a vertical direction of one polarization direction on one panel, or a quantity of antenna panels. The network-side device embodiment corresponds to the foregoing method embodiment for the network-side device. Each implementation process and implementation of the foregoing method embodiment may be applied to the network-side device embodiment, and the same technical effects can be achieved.

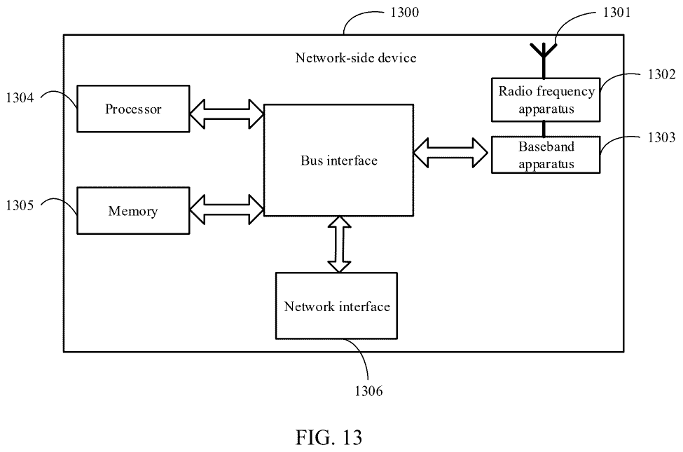

In some implementations, an embodiment of this application further provides a network-side device. As shown in FIG. 13, the network-side device 1300 includes an antenna 1301, a radio frequency apparatus 1302, a baseband apparatus 1303, a processor 1304, and a memory 1305. The antenna 1301 is connected to the radio frequency apparatus 1302. In an uplink direction, the radio frequency apparatus 1302 receives information through the antenna 1301, and sends the received information to the baseband apparatus 1303 for processing. In a downlink direction, the baseband apparatus 1303 processes to-be-sent information, and sends processed information to the radio frequency apparatus 1302. After processing the received information, the radio frequency apparatus 1302 sends processed information through the antenna 1301.

The method performed by the network-side device in the foregoing embodiment may be implemented in the baseband apparatus 1303. The baseband apparatus 1303 includes a baseband processor.

For example, the baseband apparatus 1303 may include at least one baseband board. A plurality of chips are disposed on the baseband board. As shown in FIG. 13, one of the chips is, for example, the baseband processor, and is connected to the memory 1305 by using a bus interface, to invoke a program in the memory 1305 to perform an operation of a network device shown in the foregoing method embodiment.

The network-side device may further include a network interface 1306, and the interface is, for example, a Common Public Radio Interface (CPRI).

In some implementations, the network-side device 1300 in this embodiment of this application further includes instructions or a program stored in the memory 1305 and capable of running on the processor 1304. The processor 1304 invokes the instructions or the program in the memory 1305 to perform the method performed by the modules shown in FIG. 10, and the same technical effects are achieved. To avoid repetition, details are not described herein again.

An embodiment of this application further provides a readable storage medium. The readable storage medium stores a program or instructions. The program or the instructions are executed by a processor to implement the processes in the foregoing embodiments of the channel state information transmission method, and the same technical effects can be achieved. To avoid repetition, details are not described herein again.

The processor is a processor in the terminal described in the foregoing embodiments. The readable storage medium includes a computer-readable storage medium such as a computer ROM, a RAM, a magnetic disk, or an optical disc. In some examples, the readable storage medium may be a non-transient readable storage medium.

An embodiment of this application further provides a chip. The chip includes a processor and a communication interface. The communication interface is coupled to the processor. The processor is configured to run a program or instructions to implement processes in the foregoing embodiments of the channel state information transmission method, and the same technical effects can be achieved. To avoid repetition, details are not described herein again.

It should be understood that the chip mentioned in this embodiment of this application may also be referred to as a system-level chip, a system chip, a chip system, a system on chip, or the like.

An embodiment of this application further provides a computer program/program product. The computer program/program product is stored in a storage medium. The computer program/program product is executed by at least one processor to implement processes in the foregoing embodiments of the channel state information transmission method, and the same technical effects can be achieved. To avoid repetition, details are not described herein again.

An embodiment of this application further provides a channel state information transmission system. The channel state information transmission system includes a terminal and a network-side device. The terminal is configured to perform the processes in FIG. 3 and the foregoing method embodiments. The network-side device is configured to perform the processes in FIG. 8 and the foregoing method embodiments. The same technical effects can be achieved. To avoid repetition, details are not described herein again.

It should be noted that in this specification, the term “include,” “comprise,” or any other variant thereof is intended to cover a non-exclusive inclusion, so that a process, method, article, or apparatus that includes a list of elements not only includes those elements but also includes other elements that are not expressly listed, or further includes elements inherent to such a process, method, article, or apparatus. Without more constraints, an element preceded by “includes a . . . ” does not preclude the existence of additional identical elements in the process, method, article, or apparatus that includes the element. In addition, it should be noted that the scope of the method and apparatus in the implementations of this application is not limited to performing functions in an order shown or discussed, and may further include performing functions in a basically simultaneous manner or in a reverse order based on the functions involved. For example, the described method may be performed in an order different from the described order, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by a computer software product and a necessary general-purpose hardware platform, or certainly may be implemented by hardware. The computer software product is stored in a storage medium (such as a ROM, a RAM, a magnetic disk, or an optical disc) and includes several instructions for enabling a terminal or a network-side device to perform the methods described in the embodiments of this application.

The foregoing describes the embodiments of this application with reference to the accompanying drawings. However, this application is not limited to the foregoing specific implementations. The foregoing specific implementations are merely illustrative rather than restrictive. Inspired by this application, a person of ordinary skill in the art may develop many forms of implementations without departing from principles of this application and the protection scope of the claims, and all such implementations fall within the protection scope of this application.

1. A Channel State Information (CSI) transmission method, performed by a terminal, comprising:
sending at least one CSI report, wherein:
the at least one CSI report comprises a first CSI report, the first CSI report comprises at least two pieces of CSI, a mapping order of the at least two pieces of CSI is determined based on first information, wherein the first information comprises at least one of the following:
second information associated with each of the at least two pieces of CSI,
reported content of each of the at least two pieces of CSI, or
an order of at least two spatial adaptation patterns or an order of at least two sub-configurations configured or indicated by a network-side device;
the at least two spatial adaptation patterns or the at least two sub-configurations are in a one-to-one correspondence with the at least two pieces of CSI; and
the second information comprises at least one of the following:
a sub-configuration identifier, a spatial adaptation pattern identifier, a resource-related identifier, a codebook configuration identifier, a code division multiplexing group identifier, a code division multiplexing group quantity, a port quantity, a power offset, or a first quantity, wherein the first quantity is related to at least one of the following:
a quantity of antenna ports in a horizontal direction of one polarization direction on one panel, a quantity of antenna ports in a vertical direction of one polarization direction on one panel, or a quantity of antenna panels.

2. The method according to claim 1, wherein the resource-related identifier comprises at least one of the following:
Channel State Information Reference Signal (CSI-RS) resource group identifier, CSI-RS resource set identifier, or CSI-RS resource identifier.

3. The method according to claim 1, wherein the first quantity is one of the following:
N1, N2, Ng, N1*N2, N1*N2*Ng, or N1*N2*O1*O2, wherein
N1 is the quantity of antenna ports in the horizontal direction of one polarization direction on one panel, N2 is the quantity of antenna ports in the vertical direction of one polarization direction on one panel, Ng is the quantity of antenna panels, O1 is an over-sampling multiple in the horizontal direction, and O2 is an over-sampling multiple in the vertical direction.

4. The method according to claim 1, wherein the at least two pieces of CSI are mapped in decreasing order of the second information, or the at least two pieces of CSI are mapped in increasing order of the second information.

5. The method according to claim 1, wherein the CSI part 1 of the first CSI report comprises CSI parts 1 of the at least two pieces of CSI, and the CSI parts 1 of the at least two pieces of CSI are arranged in a first mapping order; or
a CSI part 2 of the first CSI report comprises CSI parts 2 of the at least two pieces of CSI, and the CSI parts 2 of the at least two pieces of CSI are arranged in the first mapping order,
wherein the first mapping order is the mapping order, determined based on the first information, of the at least two pieces of CSI.

6. The method according to claim 5, wherein wideband CSI of each of the CSI parts 2 of the at least two pieces of CSI is arranged in front of subband CSI of each of the CSI parts 2 of the at least two pieces of CSI, and the wideband CSI of the CSI parts 2 of the at least two pieces of CSI is arranged in the first mapping order.

7. The method according to claim 6, wherein even subband CSI of each of the CSI parts 2 of the at least two pieces of CSI is arranged in front of odd subband CSI of each of the CSI parts 2 of the at least two pieces of CSI, the even subband CSI of the CSI parts 2 of the at least two pieces of CSI is arranged in the first mapping order, and the odd subband CSI of the CSI parts 2 of the at least two pieces of CSI is arranged in the first mapping order; or
the subband CSI of the CSI parts 2 of the at least two pieces of CSI is arranged in the first mapping order, and even subband CSI of a CSI part 2 of each of the at least two pieces of CSI is separately arranged in front of odd subband CSI of the CSI part 2 of the piece of CSI.

8. The method according to claim 1, further comprising:
when each of the at least one CSI report comprises a CSI part 1 and a CSI part 2, omitting or discarding at least some of the CSI parts 2 of the at least one CSI report based on a target priority order, wherein:
the target priority order comprises at least one of a first priority order, a second priority order, or a third priority order;
the first priority order comprises a priority order between the CSI parts 2 of the at least one CSI report;
the second priority order comprises: a priority of wideband CSI of each of CSI parts 2 of all CSI comprised in each of the at least one CSI report is separately higher than a priority of subband CSI of each of the CSI parts 2 of all the CSI comprised in the CSI report; and
the third priority order comprises: a priority of even subband CSI of a CSI part 2 of each piece of CSI comprised in each CSI report is separately higher than a priority of odd subband CSI of the CSI part 2 of the piece of CSI comprised in the CSI report, or a priority of even subband CSI of each of CSI parts 2 of all CSI comprised in each CSI report is separately higher than a priority of odd subband CSI of each of the CSI parts 2 of all the CSI comprised in the CSI report.

9. The method according to claim 8, wherein when the CSI report comprises at least two pieces of CSI, a target priority further comprises at least one of a fourth priority order or a fifth priority order, wherein:
the fourth priority order comprises a priority order between the wideband CSI of the CSI parts 2 of all the CSI comprised in the CSI report, wherein the priority order between the wideband CSI of the CSI parts 2 of all the CSI comprised in the CSI report is determined based on a second mapping order; and
the fifth priority order is one of the following:
the fifth priority order comprises a priority order between the subband CSI of the CSI parts 2 of all the CSI comprised in the CSI report, wherein the priority order between the subband CSI of the CSI parts 2 of all the CSI comprised in the CSI report is determined based on the second mapping order; or
the fifth priority order comprises a priority order between even subband CSI of the CSI parts 2 of all the CSI comprised in the CSI report, and a priority order between odd subband CSI of the CSI parts 2 of all the CSI comprised in the CSI report, wherein priorities of the even subband CSI of the CSI parts 2 of all the CSI comprised in the CSI report are the same, or priorities of the even subband CSI of the CSI parts 2 of all the CSI comprised in the CSI report are determined based on the second mapping order; and priorities of the odd subband CSI of the CSI parts 2 of all the CSI comprised in the CSI report are the same, or priorities of the odd subband CSI of the CSI parts 2 of all the CSI comprised in the CSI report are determined based on the second mapping order,
wherein the second mapping order is a mapping order determined based on the first information.

10. The method according to claim 8, wherein the omitting or discarding at least some of the CSI parts 2 of the at least one CSI report based on a target priority order comprises:
omitting or discarding the CSI parts 2 of the at least one CSI report successively in increasing order of priorities based on the target priority order, until a code rate of the CSI parts 2 is less than or equal to a first preset value.

11. The method according to claim 1, wherein:
a mapping order of first CSI precedes a mapping order of second CSI; or
a mapping order of first CSI follows a mapping order of second CSI; wherein:
the first CSI is CSI with some CSI fields being omitted from reported content in the at least two pieces of CSI; or
the first CSI is CSI with CSI field sharing in reported content in the at least two pieces of CSI; and
wherein the second CSI is CSI except the first CSI in the at least two pieces of CSI.

12. The method according to claim 1, wherein the spatial adaptation pattern or the sub-configuration comprises at least one of the following:
a spatial adaptation pattern identifier;
a sub-configuration identifier;
a CSI-RS resource group identifier;
a CSI-RS resource identifier;
a port quantity;
a port subset;
a power offset;
a quantity of antenna ports in a horizontal direction of a single polarization direction on each panel;
a quantity of antenna ports in a vertical direction of a single polarization direction on each panel;
a quantity of antenna ports;
reported content of CSI; or
a codebook configuration.

13. The method according to claim 1, wherein the first CSI report further comprises third information, and the third information is configured to assist the network-side device in confirming content of the first CSI report,
wherein the third information comprises at least one of the following:
a quantity of pieces of CSI comprised in the first CSI report;
a quantity of sub-configurations associated with the CSI comprised in the first CSI report;
a quantity of spatial adaptation patterns associated with the CSI comprised in the first CSI report;
a CSI-RS Resource Indicator (CRI) associated with the CSI comprised in the first CSI report;
a CSI-RS resource group identifier associated with the CSI comprised in the first CSI report;
a CSI-RS resource identifier associated with the CSI comprised in the first CSI report;
a spatial adaptation pattern identifier associated with the CSI comprised in the first CSI report; or
a sub-configuration identifier associated with the CSI comprised in the first CSI report.

14. The method according to claim 1, wherein:
a subband differential Channel Quality Indicator (CQI) of a first transport block of each of the at least two pieces of CSI is separately located in a CSI part 2 of the piece of CSI;
when the at least two pieces of CSI comprise third CSI, a CSI part 2 of the third CSI comprises only wideband CSI; and
the third CSI is CSI with CSI field sharing in reported content in the at least two pieces of CSI.

15. The method according to claim 1, wherein the at least one CSI report is carried on a Physical Uplink Control CHannel (PUCCH), and each of the CSI report comprises only a CSI part 1; and
the method further comprises:
when there are at least two to-be-sent CSI reports on the PUCCH, omitting or discarding the CSI reports in the at least two CSI reports successively in increasing order of priorities, until a code rate of the CSI reports is less than or equal to a second preset value.

16. A Channel State Information (CSI) transmission method, performed by a network-side device, comprising:
receiving at least one CSI report, wherein:
the at least one CSI report comprises a first CSI report;
the first CSI report comprises at least two pieces of CSI;
a mapping order of the at least two pieces of CSI is determined based on first information; and
the first information comprises at least one of the following:
second information associated with each of the at least two pieces of CSI;
reported content of each of the at least two pieces of CSI; or
an order of at least two spatial adaptation patterns or an order of at least two sub-configurations configured or indicated by the network-side device;
the at least two spatial adaptation patterns or the at least two sub-configurations are in a one-to-one correspondence with the at least two pieces of CSI; and
the second information comprises at least one of the following:
a sub-configuration identifier, a spatial adaptation pattern identifier, a resource-related identifier, a codebook configuration identifier, a code division multiplexing group identifier, a code division multiplexing group quantity, a port quantity, a power offset, or a first quantity,
wherein the first quantity is related to at least one of the following:
a quantity of antenna ports in a horizontal direction of one polarization direction on one panel, a quantity of antenna ports in a vertical direction of one polarization direction on one panel, or a quantity of antenna panels.

17. The method according to claim 16, wherein the at least two pieces of CSI are mapped in decreasing order of the second information, or the at least two pieces of CSI are mapped in increasing order of the second information.

18. The method according to claim 16, wherein the CSI part 1 of the first CSI report comprises CSI parts 1 of the at least two pieces of CSI, and the CSI parts 1 of the at least two pieces of CSI are arranged in a first mapping order; or
a CSI part 2 of the first CSI report comprises CSI parts 2 of the at least two pieces of CSI, and the CSI parts 2 of the at least two pieces of CSI are arranged in the first mapping order,
wherein the first mapping order is the mapping order, determined based on the first information, of the at least two pieces of CSI.

19. The method according to claim 18, wherein wideband CSI of each of the CSI parts 2 of the at least two pieces of CSI is arranged in front of subband CSI of each of the CSI parts 2 of the at least two pieces of CSI, and the wideband CSI of the CSI parts 2 of the at least two pieces of CSI is arranged in the first mapping order.

20. The method according to claim 19, wherein even subband CSI of each of the CSI parts 2 of the at least two pieces of CSI is arranged in front of odd subband CSI of each of the CSI parts 2 of the at least two pieces of CSI, the even subband CSI of the CSI parts 2 of the at least two pieces of CSI is arranged in the first mapping order, and the odd subband CSI of the CSI parts 2 of the at least two pieces of CSI is arranged in the first mapping order; or
the subband CSI of the CSI parts 2 of the at least two pieces of CSI is arranged in the first mapping order, and even subband CSI of a CSI part 2 of each of the at least two pieces of CSI is separately arranged in front of odd subband CSI of the CSI part 2 of the piece of CSI.
